(19) United States
(12) Patent Application Publication
(10) Pub. No.: US 2025/0236706 A1
(43) Pub. Date: Jul. 24, 2025

(54) MAKING A HYDROGEL FROM A SACRIFICIAL IONIC SCAFFOLD

(71) Applicant: Government of the United States of America, as represented by the Secretary of Commerce, Gaithersburg, MD (US)

(72) Inventors: Thomas John Kolibaba, Westminster, CO (US); Jason Philip Killgore, Silverthorne, CO (US)

(21) Appl. No.: 19/058,167

(22) Filed: Feb. 20, 2025

Related U.S. Application Data
(63) Continuation-in-part of application No. 18/206,667, filed on Jun. 7, 2023.
(60) Provisional application No. 63/350,265, filed on Jun. 8, 2022.

(51) Int. Cl. C08J 3/075; C08J 7/02; C08K 5/00

(52) U.S. Cl. CPC C08J 3/075; C08J 7/02; C08K 5/0025; C08J 2379/02; C08J 2433/08

(57) ABSTRACT

A process for making a hydrogel from a sacrificial ionic scaffold includes providing a sacrificial ionic scaffold including a cationic poly-ammonium electrolyte and an anionic poly-acrylate electrolyte complexed together. The process further includes treating the sacrificial ionic scaffold with a basic solution to form the hydrogel. The sacrificial ionic scaffold provides a rigid template for the hydrogel, enabling the creation of complex shapes. The basic solution degrades the scaffold, converting it into a soft, water-swollen hydrogel.

### CROSS-REFERENCE TO RELATED APPLICATION

This application is a continuation-in-part and claims benefit of U.S. patent application Ser. No. 18/206,667 (filed Jun. 7, 2023), which claims the benefit of U.S. Provisional Patent Application Ser. No. 63/350,265 (filed Jun. 8, 2022), both of which are herein incorporated by reference in its entirety. All patents, patent applications, and publications cited herein are hereby incorporated by reference in their entirety.

### STATEMENT REGARDING FEDERALLY SPONSORED RESEARCH

This invention was made with United States Government support from the National Institute of Standards and Technology (NIST), an agency of the United States Department of Commerce. The Government has certain rights in this invention.

### BACKGROUND

The present invention generally relates to the field of making a hydrogel from a sacrificial ionic scaffold, and more particularly to techniques for forming hydrogels with precisely controlled shapes and dimensions by leveraging the properties of sacrificial ionic scaffolds.

The fabrication of hydrogels with intricate, three-dimensional structures has long presented a significant challenge. Traditional hydrogel manufacturing methods, while capable of producing basic shapes, struggle with the inherent compliance of these materials. Hydrogels, due to their high water content and flexible polymer networks, readily deform under stress, making it difficult to maintain precise geometries during processing. This limitation is particularly acute when aiming for complex structures with small features or high aspect ratios, often required for applications such as tissue engineering, microfluidics, and drug delivery. Existing methods, like molding and extrusion, are often too crude for these demanding specifications, leading to inaccuracies, long processing times, or the need for specialized and expensive equipment. Furthermore, conventional hydrogels often require low solids content, exacerbating issues like swelling and distortion during fabrication.

Current efforts to overcome these limitations involve techniques like stereolithography and other forms of additive manufacturing. However, even these advanced approaches are often hampered by the limitations of the hydrogel materials themselves. The difficulty in achieving high resolution and dimensional stability stems from the delicate balance between maintaining sufficient fluidity for printing and achieving the necessary structural integrity in the final product. Low viscosity formulations, while conducive to printing, can result in weak, easily damaged structures. Conversely, higher viscosity hydrogels, while more robust, are difficult to process and can clog printing nozzles or fail to cure properly. This fundamental trade-off has significantly hindered the progress of high-precision hydrogel fabrication.

Sacrificial scaffolding offers an intriguing avenue for circumventing these challenges. By providing temporary structural support during the manufacturing process, a sacrificial scaffold allows for the creation of complex hydrogel shapes that would be otherwise unattainable. The scaffold, typically made from a readily removable material, reinforces the hydrogel precursor during fabrication, enabling the formation of intricate geometries and fine details. Once the desired structure is formed, the scaffold can be selectively dissolved or otherwise removed, leaving behind a pure hydrogel structure that conforms to the original scaffold template. While promising, the challenge lies in identifying suitable scaffold materials that are both strong enough to provide adequate support and easily removable without damaging the delicate hydrogel network.

It is therefore an objective of the present invention to provide a novel process for making hydrogels from sacrificial ionic scaffolds, thereby overcoming the above-mentioned disadvantages of the prior art at least in part. Accordingly, methods and equipment for creating hydrogels with precise geometries and complex shapes using readily fabricated and selectively removable ionic scaffolds would be advantageous and would be favorably received in the art.

### BRIEF DESCRIPTION

One aspect of the present invention relates to a process for making a hydrogel from a sacrificial ionic scaffold. A hydrogel is a network of polymer chains that are hydrophilic, sometimes found as a colloidal gel in which water is the dispersion medium. Hydrogels are highly absorbent (they can contain over 90% water) natural or synthetic polymers. A sacrificial ionic scaffold is a temporary structure composed of ionically bound polymers that provides support during hydrogel fabrication.

It may be provided that the process involves providing a sacrificial ionic scaffold comprising a cationic poly-ammonium electrolyte and an anionic poly-acrylate electrolyte complexed together. A polyelectrolyte is a polymer with repeating units that bear an electrolyte group. These groups will dissociate in aqueous solutions (e.g., water), making the polymers charged. Polyelectrolyte complexes (PECs) are made up of at least two oppositely-charged polyelectrolytes. These materials are held together by reversible ionic bonds and will precipitate out of solution when mixed. Providing a pre-formed ionic scaffold offers a distinct advantage by establishing a robust, well-defined template for the subsequent hydrogel formation. This pre-formed structure allows for intricate shapes and precise dimensions to be set before the hydrogel itself is created, mitigating the challenges associated with handling and shaping the compliant hydrogel material directly. This arrangement uses the inherent properties of polyelectrolyte complexes, capitalizing on their ability to form stable, interconnected networks through ionic interactions. This provides a strong, yet ultimately reversible, framework for the hydrogel.

It may further be provided that the process includes treating the sacrificial ionic scaffold with a basic solution to form the hydrogel. A basic solution is an aqueous solution with a pH greater than 7. Treating the sacrificial ionic scaffold with a basic solution triggers a transformation in the material, converting the rigid ionic scaffold into a pliable hydrogel. One advantage of this method is the controlled and selective nature of the transformation. The basic solution disrupts the ionic bonds holding the scaffold together, allowing the polymer chains to reconfigure and absorb water, thus forming the desired hydrogel. This chemical process allows for a clean and efficient transition, leaving behind a hydrogel that retains the intricate shape and fine details of the original scaffold. This conversion process is particularly advantageous for creating complex, three-dimensional hydrogel structures, which are difficult to achieve through traditional manufacturing methods.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1 shows, according to some embodiments, the conversion of a printed polyelectrolyte complex (PEC) into a hydrogel after treatment with a basic solution.

FIG. 2 shows, according to some embodiments, the increased swelling of a hydrogel after base treatment followed by neutralization.

FIG. 3 shows, according to some embodiments, the swelling ratios of printed PEC samples under different solution conditions.

FIG. 4 shows, according to some embodiments, mechanical data for force versus percent compression of hydrogel samples under different solution conditions.

FIG. 5 shows, according to some embodiments, conversion of a printed sacrificial ionic scaffold into a hydrogel for treatment with various solutions.

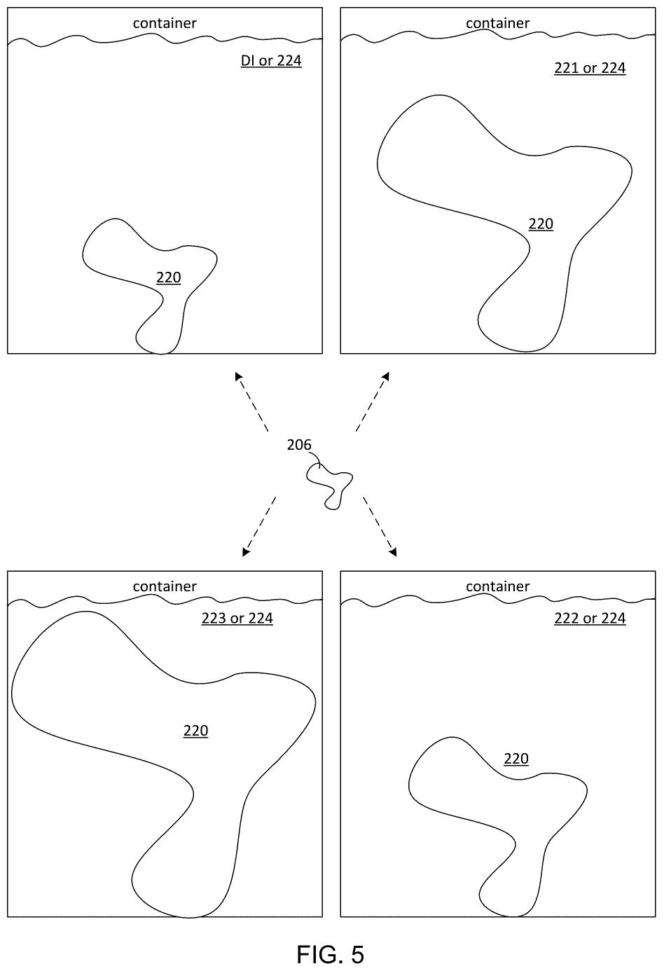

### DETAILED DESCRIPTION

A detailed description of one or more embodiments is presented herein by way of exemplification and not limitation.

Conventional methods for fabricating hydrogels often struggle to achieve complex, three-dimensional shapes with high fidelity. The compliant nature of hydrogels makes them prone to deformation during processing, limiting the achievable complexity and precision. Existing techniques, such as molding and extrusion, are often inadequate for creating intricate structures, particularly those with small features or high aspect ratios. These limitations have significantly restricted the potential applications of hydrogels, especially in fields requiring precise control over shape and form, like tissue engineering and microfluidics.

The process for making a hydrogel from a sacrificial ionic scaffold described herein overcomes these limitations in shape complexity and dimensional accuracy. It has been discovered that a process for making a hydrogel from a sacrificial ionic scaffold allows for the creation of intricate hydrogel structures with unprecedented ease and precision. One key advantage of this process lies in the use of a sacrificial ionic scaffold. This scaffold, formed from a complex of cationic and anionic polyelectrolytes, provides a rigid, pre-shaped template for the hydrogel. By treating this scaffold with a basic solution, the ionic bonds within the scaffold are disrupted, triggering a transformation into a soft, water-swollen hydrogel. This approach neatly sidesteps the challenges of manipulating the hydrogel directly during fabrication. This process offers several notable advantages. The use of a pre-formed scaffold ensures that the final hydrogel precisely replicates the scaffold's shape, enabling the fabrication of highly complex geometries that would be difficult or impossible to achieve through other methods. The basic solution treatment offers a simple, yet effective, means of converting the scaffold into a hydrogel, facilitating a clean and controlled transition. Moreover, the properties of the resulting hydrogel, such as its swelling behavior and mechanical characteristics, can be further tuned by adjusting the composition of the initial scaffold and the conditions of the base treatment. This versatility makes the process adaptable to a wide range of applications, offering a powerful new tool for hydrogel fabrication.

In an embodiment, a process for making a hydrogel (220) from a sacrificial ionic scaffold (206) comprises providing a sacrificial ionic scaffold (206) comprising a cationic poly-ammonium electrolyte (202) and an anionic poly-acrylate electrolyte (208) complexed together; and treating the sacrificial ionic scaffold (206) with a basic solution to form the hydrogel (220). In an embodiment, the sacrificial ionic scaffold (206) is formed by a process comprising providing an additive manufacturing polyelectrolyte resin (200) comprising the cationic poly-ammonium electrolyte (202), an anionic organic acrylate monomer (203), a photoinitiator (204), and a chemical modifier (218); subjecting the additive manufacturing polyelectrolyte resin (200) to polymerizing light (219) to polymerize the anionic organic acrylate monomer (203) and form the anionic poly-acrylate electrolyte (208); and complexing the cationic poly-ammonium electrolyte (202) with the anionic poly-acrylate electrolyte (208) to form the sacrificial ionic scaffold (206). In an embodiment, the chemical modifier (218) is selected from the group consisting of a photoabsorber (215), an ion dispersion solvent (205) comprising an organic reactive diluent (216), and a combination thereof. In an embodiment, the ion dispersion solvent (205) reacts with the anionic organic acrylate monomer (203) to form an anionic copolymer (217). In an embodiment, the process further comprises neutralizing the hydrogel (220) after treating with the basic solution. In an embodiment, treating the sacrificial ionic scaffold (206) with the basic solution comprises immersing the sacrificial ionic scaffold (206) in the basic solution for a selected period, e.g., at least 16 hours. In an embodiment, the basic solution has a pH greater than 12. In an embodiment, the process further comprises soaking the hydrogel (220) in water after treating with the basic solution. In an embodiment, the process further comprises adjusting the pH of the water to tune the degree of swelling of the hydrogel (220). In an embodiment, the additive manufacturing polyelectrolyte resin (200) further comprises a covalent crosslinker (207). In an embodiment, the sacrificial ionic scaffold (206) is three-dimensionally printed.

In an embodiment, the process for making the hydrogel (220) involves providing a sacrificial ionic scaffold (206). This scaffold functions as a temporary, rigid support structure during hydrogel formation. It comprises a cationic poly-ammonium electrolyte (202) and an anionic poly-acrylate electrolyte (208) complexed together through ionic interactions. This ionic complexation creates a robust network, enabling the scaffold to maintain its shape and provide structural integrity. The scaffold can be fabricated using various techniques, such as additive manufacturing, allowing for the creation of intricate three-dimensional shapes. The choice of specific polyelectrolytes (202, 208) will depend on the intended application and desired hydrogel properties. Biocompatible and biodegradable options are available for biomedical uses, while other polyelectrolytes might be chosen based on their mechanical strength, chemical resistance, or other relevant characteristics. This use of a pre-formed, rigid structure addresses the limitations of conventional hydrogel processing, where the compliance of the material often makes it challenging to achieve complex shapes with high precision. Details of the sacrificial ionic scaffold (206), the cationic poly-ammonium electrolyte (202), and the anionic poly-acrylate electrolyte (208) in described in U.S. patent application Ser. No. 18/206,667, the disclosure of which is incorporated herein in its entirety.

Making the hydrogel (220) involves treating the sacrificial ionic scaffold (206) with a basic solution to form the hydrogel (220). This treatment triggers a chemical transformation, converting the rigid ionic scaffold into a soft, pliable hydrogel. The basic solution disrupts the ionic bonds within the scaffold, causing the polyelectrolyte complex to dissociate and absorb water, leading to the formation of the hydrogel. The choice of base and its concentration can depend on the specific polyelectrolytes used in the scaffold. The treatment conditions, such as temperature and duration, can be adjusted to control the rate and extent of hydrogel formation. This chemically induced transformation offers a significant advantage over physical methods of hydrogel shaping. It allows for a clean and complete conversion, minimizing the presence of residual scaffold material in the final hydrogel. Moreover, it provides a mechanism for tailoring the properties of the resulting hydrogel, such as its swelling behavior and mechanical strength, by adjusting the treatment parameters.

This method represents an innovative approach to hydrogel fabrication. The use of a sacrificial ionic scaffold allows for the creation of complex shapes with high fidelity, overcoming the limitations of traditional techniques. The controlled chemical conversion, induced by the basic solution, ensures a clean and efficient transformation into the final hydrogel product. This combination of a pre-shaped template and a chemically driven conversion process offers significant improvements in functionality, enabling the creation of intricate hydrogel structures with tailored properties. The novelty of this method is evident in its unique approach to hydrogel processing, providing a non-obvious solution to the limitations of existing techniques. The ability to create complex, functional hydrogels has clear utility in a wide range of applications, including biomedicine, microfluidics, and materials science.

In an embodiment, the sacrificial ionic scaffold (206) is formed through a process that can begin with an additive manufacturing polyelectrolyte resin (200), a specially formulated mixture containing the building blocks for the scaffold. The resin (200) includes a cationic poly-ammonium electrolyte (202), an anionic organic acrylate monomer (203), a photoinitiator (204), and a chemical modifier (218). This resin is then subjected to polymerizing light (219), initiating a photopolymerization reaction that converts the anionic organic acrylate monomer (203) into the corresponding anionic poly-acrylate electrolyte (208). The cationic and anionic polyelectrolytes then complex together, forming the sacrificial ionic scaffold (206). This method offers precise control over the scaffold's composition and structure, enabling the creation of scaffolds with tailored properties. Various photoinitiators and chemical modifiers can be employed to optimize the photopolymerization process and adjust the characteristics of the resulting scaffold. For instance, the chemical modifier could be a photoabsorber (215), an ion dispersion solvent (205) containing an organic reactive diluent (216), or a combination of these. The ion dispersion solvent (205) can further react with the anionic organic acrylate monomer (203), creating an anionic copolymer (217) that contributes to the scaffold's final properties. This level of control allows for the design of scaffolds with specific mechanical strengths, degradation rates, and biocompatibility profiles, depending on the intended application. The use of additive manufacturing techniques further enhances the process by allowing for the fabrication of scaffolds with intricate, three-dimensional geometries.

Following the formation of the hydrogel (220), a neutralizing step can be introduced to further refine its properties. This neutralization process involves adjusting the pH of the hydrogel to a neutral value. This can be achieved by washing the hydrogel with a neutral solution or by immersing it in a buffer solution. Neutralization can enhance the biocompatibility of the hydrogel, making it more suitable for applications involving living cells or tissues. It also influences the hydrogel's swelling behavior and mechanical properties, providing an additional level of control over the final material. The specific method of neutralization can be tailored to the particular application and the desired hydrogel characteristics.

The treatment of the sacrificial ionic scaffold (206) with the basic solution can be further defined by specifying the duration of immersion. Immersing the scaffold in the basic solution for a specific period, such as at least 16 hours, ensures complete conversion to the hydrogel. This controlled immersion time contributes to the reproducibility and reliability of the process, ensuring consistent results. Furthermore, a covalent crosslinker (207) can be incorporated into the additive manufacturing polyelectrolyte resin (200) to enhance the mechanical properties of the scaffold and influence the characteristics of the final hydrogel. This addition provides an additional degree of control over the hydrogel's structure and performance. After the initial treatment with the basic solution, the hydrogel can be further soaked in water. This soaking step removes any residual basic solution and allows the hydrogel to fully swell and equilibrate. Adjusting the pH of the water during this soaking process offers another avenue for tuning the degree of swelling of the hydrogel. By carefully controlling the pH, the desired swelling behavior and mechanical properties of the hydrogel can be achieved. Finally, for intricate and complex hydrogel designs, a three-dimensionally printed sacrificial ionic scaffold can be used. This approach leverages the capabilities of additive manufacturing to create scaffolds with precise geometries, enabling the fabrication of hydrogels with unprecedented levels of structural complexity.

This multifaceted process, with its numerous variations and refinements, offers unparalleled control over hydrogel fabrication. The ability to tailor the scaffold's composition, the treatment conditions, and the post-treatment steps provides a powerful toolbox for creating hydrogels with specific properties and functionalities. The incorporation of additive manufacturing and the use of covalent crosslinkers further enhance the versatility and capabilities of this method.

The fabrication of the sacrificial ionic scaffold (206) can be achieved through various additive manufacturing techniques, such as vat photopolymerization or direct ink writing. In vat photopolymerization, the polyelectrolyte resin (200) is selectively cured layer by layer using patterned light exposure. This method offers high resolution and the ability to create complex three-dimensional shapes. Direct ink writing, on the other hand, involves extruding the resin (200) in a controlled manner to build the scaffold layer by layer. This technique can create scaffolds with varying material compositions or gradients. The choice of additive manufacturing method will depend on the specific requirements of the desired scaffold, such as its size, complexity, and material properties. Further control over the scaffold's properties can be achieved by incorporating additional components into the resin (200), such as plasticizers, reinforcing agents, or porosity-inducing agents.

The treatment of the sacrificial ionic scaffold (206) with a basic solution can be performed using a variety of methods. Immersion of the scaffold in a basic solution is a common approach, where the concentration and pH of the solution are controlled to achieve the desired degree of scaffold degradation and hydrogel formation. Alternative methods include spraying or coating the scaffold with the basic solution or using a perfusion system to circulate the solution through the scaffold. The optimal treatment method will depend on the scaffold's geometry and the desired properties of the resulting hydrogel. Furthermore, the temperature and duration of the treatment can be adjusted to fine-tune the hydrogel's characteristics.

Post-treatment processing of the hydrogel (220) can involve additional steps to further optimize its properties or adapt it for specific applications. Washing the hydrogel with a neutral solution removes residual base and any unreacted polyelectrolyte components. This washing step can also help to control the swelling behavior of the hydrogel. Surface modification techniques, such as chemical functionalization or coating, can be used to alter the hydrogel's surface properties, such as its hydrophobicity, biocompatibility, or adhesion to other materials. Sterilization methods, like autoclaving or irradiation (e.g., with gamma radiation), can be used for biomedical applications to ensure the hydrogel is free from contaminants. Finally, the hydrogel can be further processed into specific shapes or forms using techniques like molding, cutting, or bonding, depending on the requirements of the intended application. These additional processing steps provide a wide range of options for customizing the hydrogel's properties and adapting it for diverse applications.

Various components for and preparing sacrificial ionic scaffold (206) are described in U.S. patent application Ser. No. 18/206,667, which is incorporated by reference herein in its entirety.

The hydrogel (220) formed through this innovative process represents a significant advancement in materials science. Hydrogels are three-dimensional networks of hydrophilic polymers capable of absorbing and retaining substantial amounts of water. Their unique properties, including biocompatibility, tunable mechanical characteristics, and responsiveness to external stimuli, make them highly attractive for a diverse array of applications. The hydrogel (220) can be formed through the controlled degradation of a sacrificial ionic scaffold (206), inheriting the intricate shape and structural details of the scaffold. This process allows for the creation of hydrogels with precisely defined geometries, overcoming the limitations of traditional hydrogel fabrication methods.

The physical structure of the hydrogel (220) is characterized by its interconnected polymer network and high water content. The polymer chains within the hydrogel are crosslinked, either physically through entanglements or chemically through covalent bonds, forming a three-dimensional matrix. This network structure allows the hydrogel to absorb and retain water, giving it its characteristic soft and pliable nature. The pore size within the hydrogel network can be controlled by adjusting the crosslinking density, influencing its permeability and diffusion properties. The degree of swelling, a useful property of hydrogels, is determined by the balance between the osmotic pressure driving water into the network and the elastic forces of the polymer chains resisting expansion. The swelling behavior can be tailored by adjusting the composition of the polymer network, the crosslinking density, and the ionic strength of the surrounding environment. The mechanical properties of the hydrogel, such as its stiffness and elasticity, are also influenced by these factors, allowing for the creation of hydrogels with a wide range of mechanical characteristics.

The hydrogel's (220) interconnectivity with other elements in the system is useful to its functionality. It is derived directly from the sacrificial ionic scaffold (206), inheriting its precise three-dimensional shape. This intimate relationship between the scaffold and the hydrogel ensures that the final hydrogel structure faithfully replicates the intricate design of the scaffold. Furthermore, the hydrogel (220) can be further modified or functionalized by incorporating additional components, such as bioactive molecules, nanoparticles, or other polymers, into its network. These additions can enhance the hydrogel's performance in specific applications, such as drug delivery, tissue engineering, or sensing.

The hydrogel's (220) operability and functionality stem from its unique combination of properties. Its high water content mimics the environment of biological tissues, making it biocompatible and suitable for various biomedical applications. Its tunable mechanical properties allow it to be adapted to specific mechanical requirements, such as matching the stiffness of surrounding tissues in implants. The hydrogel's porous structure allows for the diffusion of nutrients and waste products, useful for supporting cell growth in tissue engineering applications. Moreover, the hydrogel's responsiveness to external stimuli, such as pH or temperature changes, makes it suitable for creating smart materials that can adapt to changing conditions.

The benefits of using a hydrogel (220) include its precise shape replication from the sacrificial ionic scaffold (206) that enables the creation of complex, three-dimensional hydrogel structures with high fidelity. The controlled degradation of the scaffold allows for a clean and efficient transition to the hydrogel, minimizing the presence of residual scaffold material. The tunable properties of the hydrogel, including its swelling, mechanical characteristics, and responsiveness to stimuli, make it adaptable to a wide range of applications. The biocompatibility of many hydrogels further expands their potential uses in biomedical fields, such as drug delivery, tissue engineering, and wound healing. The hydrogel's ability to encapsulate and release bioactive molecules offers a controlled drug delivery platform, while its porous structure provides a supportive environment for cell growth and tissue regeneration.

The hydrogel's (220) implementation allows for numerous variations and alternatives. Different polymer compositions can be used to create hydrogels with specific properties. The crosslinking density can be adjusted to tune the hydrogel's porosity and mechanical strength. The incorporation of additives, such as nanoparticles or bioactive molecules, can further enhance the hydrogel's functionality. The degradation rate of the hydrogel can be controlled by choosing biodegradable polymers or by incorporating degradable linkages into the polymer network. These variations provide a wide range of options for tailoring the hydrogel's properties to meet the specific requirements of various applications. For instance, a highly swollen hydrogel with low stiffness might be preferred for drug delivery, while a more rigid and mechanically robust hydrogel could be more suitable for a tissue engineering scaffold. The hydrogel's dimensions can range from micrometers to centimeters, specifically from 10 micrometers to 5 centimeters, and more specifically from 100 micrometers to 1 centimeter. The porosity of the hydrogel can be from 10% to 90%, specifically from 20% to 80%, and more specifically from 30% to 70%. The swelling ratio, defined as the ratio of the hydrogel's volume in the swollen state to its volume in the dry state, can be from 2 to 100, specifically from 5 to 50, and more specifically from 10 to 25.

The basic solution (221) plays a role in the transformation of the sacrificial ionic scaffold (206) into the hydrogel (220). This solution, characterized by its alkaline pH, initiates a controlled degradation of the scaffold, facilitating the formation of the desired hydrogel structure. The basic solution's precise composition and concentration are selected to ensure a clean and efficient conversion process, minimizing the presence of residual scaffold material in the final hydrogel product. The choice of base, its concentration, and the treatment conditions are parameters that influence the properties of the resulting hydrogel. The functionality of the basic solution (221) lies in its ability to disrupt the ionic bonds within the sacrificial ionic scaffold (206). The scaffold, composed of a complex between cationic and anionic polyelectrolytes, relies on these ionic interactions for its structural integrity. The basic solution, with its abundance of hydroxide ions (OH⁻), interferes with these ionic bonds, causing the polyelectrolyte complex to dissociate. This dissociation process weakens the scaffold's structure, allowing the polymer chains to relax and absorb water, ultimately leading to the formation of the hydrogel (220). The extent of scaffold degradation and the rate of hydrogel formation are determined by the strength and concentration of the basic solution, as well as the treatment conditions, such as temperature and duration.

The basic solution (221) can be implemented using a variety of alkaline substances. Common choices include sodium hydroxide (NaOH), potassium hydroxide (KOH), and ammonium hydroxide (NH₄OH). The concentration of the basic solution can range from 0.1 M to 2.0 M, specifically from 0.2 M to 1.5 M, and more specifically from 0.5 M to 1.0 M. The optimal concentration depends on the specific polyelectrolytes used in the sacrificial ionic scaffold and the desired properties of the resulting hydrogel. Higher concentrations typically lead to faster scaffold degradation and hydrogel formation, but may also increase the risk of damaging the delicate polymer network. The pH of the basic solution can range from 8 to 14, specifically from 9 to 13, and more specifically from 10 to 12. The pH can be chosen to balance the need for efficient scaffold degradation with the preservation of the hydrogel's structural integrity.

The benefits of using a basic solution (221) in this process are manifold. It provides a simple, yet effective method for transforming the sacrificial ionic scaffold (206) into the hydrogel (220). The controlled degradation process ensures a clean transition, minimizing the presence of residual scaffold material in the final product. The ability to adjust the basic solution's composition, concentration, and treatment conditions offers flexibility in tailoring the properties of the resulting hydrogel, such as its swelling behavior and mechanical strength. This controlled conversion process is a significant advantage over conventional hydrogel fabrication methods, which often struggle to achieve complex shapes and precise control over material properties.

Variations and alternatives in implementing the basic solution (221) offer further opportunities for optimizing the hydrogel formation process. Different bases can be employed, each with its own characteristics and advantages. For instance, organic bases, such as amines, may be preferred for certain applications due to their lower toxicity or specific interactions with the polyelectrolytes. The treatment method can also be varied. Immersion of the scaffold in the basic solution is a common approach, but alternative methods, like spraying or perfusion, can be employed for specific scaffold geometries or desired hydrogel properties. The treatment conditions, such as temperature and duration, can be adjusted to fine-tune the hydrogel's characteristics. For example, a higher temperature might accelerate the conversion process, while a longer treatment time might be necessary for complete scaffold degradation. The use of buffer solutions can help maintain a stable pH during the treatment process, ensuring consistent and reproducible results. Moreover, additives, such as chelating agents or surfactants, can be incorporated into the basic solution to modify the degradation process or enhance the hydrogel's properties.

Some embodiments for making the hydrogel (220) include treatment with an acidic solution (222). The acidic solution (222) provides an alternative approach to modulating the properties of the hydrogel (220) formed from the sacrificial ionic scaffold (206). While a basic solution (221) triggers the initial transformation of the scaffold into the hydrogel, an acidic solution (222) can be employed in subsequent processing steps to fine-tune the hydrogel's characteristics. The acidic solution's interaction with the hydrogel's polymer network can influence its swelling behavior, mechanical properties, and overall stability. This provides an additional level of control over the final hydrogel material, expanding the range of achievable properties and potential applications.

The functionality of the acidic solution (222) stems from its ability to alter the charge distribution and conformation of the polymer chains within the hydrogel (220). The hydrogel, formed from polyelectrolytes, contains charged groups along its polymer chains. The acidic solution, with its high concentration of hydrogen ions (H⁺), can protonate these charged groups, influencing the electrostatic interactions within the hydrogel network. This change in charge distribution can affect the hydrogel's swelling behavior, causing it to either shrink or swell depending on the specific polyelectrolytes used and the pH of the acidic solution. The acidic solution can also influence the conformation of the polymer chains, affecting the hydrogel's mechanical properties, such as its stiffness and elasticity.

The acidic solution (222) can be implemented using a variety of acids. Common choices include hydrochloric acid (HCl), sulfuric acid (H₂SO₄), and acetic acid (CH₃COOH). The concentration of the acidic solution can range from 0.01 M to 2.0 M, specifically from 0.5 M to 1.5 M, and more specifically from 0.75 M to 1.25 M. The optimal concentration will depend on the specific polyelectrolytes comprising the hydrogel and the desired degree of property modification. The pH of the acidic solution, a measure of its acidity, can range from 1 to 6, specifically from 2 to 5, and more specifically from 3 to 4. The pH is chosen to achieve the desired effect on the hydrogel's properties without causing damage to the polymer network.

The benefits of using an acidic solution (222) include the ability to fine-tune the hydrogel's properties after its initial formation from the sacrificial ionic scaffold (206). This post-treatment modification offers a means of adjusting the hydrogel's swelling behavior and mechanical characteristics, expanding the range of achievable properties. For instance, an acidic solution can be used to reduce the swelling of a hydrogel that has been excessively swollen by the basic solution treatment, improving its dimensional stability. It can also be used to increase the stiffness of a hydrogel, making it more suitable for applications requiring greater mechanical strength.

Variations and alternatives for implementing the acidic solution (222) provide additional flexibility in tailoring the hydrogel's properties. Different acids can be employed, each with its own specific effects on the hydrogel's polymer network. The treatment method can also be varied, similar to the basic solution treatment. Immersion, spraying, or perfusion can be used depending on the hydrogel's geometry and the desired degree of modification. The treatment conditions, including temperature and duration, can be adjusted to optimize the modification process. Buffer solutions can be employed to maintain a stable pH during treatment, ensuring consistent results. Additives, like crosslinking agents or stabilizing agents, can be incorporated into the acidic solution to further modify the hydrogel's properties. For example, the addition of a crosslinking agent could increase the hydrogel's mechanical strength, while a stabilizing agent could improve its resistance to degradation.

Some embodiments for making the hydrogel (220) include treatment with a neutral solution (223). The neutral solution (223) serves in processing of the hydrogel (220), primarily in post-treatment steps to refine the hydrogel's properties and prepare it for its intended application. While the basic solution (221) initiates the transformation of the sacrificial ionic scaffold (206) into the hydrogel, and the acidic solution (222) can be used to modulate specific properties, the neutral solution (223) plays a vital role in washing, equilibrating, and stabilizing the hydrogel. This ensures the removal of residual chemicals, stabilizes the hydrogel's structure, and optimizes its performance in its final application.

The neutral solution (223) removes residual chemicals from the hydrogel (220) after its formation and any subsequent treatments. Following the treatment with the basic solution (221), the hydrogel may contain residual base, unreacted polyelectrolytes, or other byproducts of the conversion process. Similarly, if an acidic solution (222) is used for property modification, residual acid may be present. The neutral solution (223), typically water or a buffered saline solution, effectively washes away these residual chemicals, ensuring the purity and biocompatibility of the final hydrogel product. This washing step also helps to equilibrate the hydrogel's swelling, as the neutral solution allows the hydrogel to reach its equilibrium swelling state without further chemical modification.

The neutral solution (223) can be implemented using deionized water or a buffered saline solution. Deionized water, purified to remove mineral ions, provides a clean and neutral environment for washing the hydrogel. Buffered saline solutions, containing specific salts and buffering agents, can further stabilize the hydrogel's structure and mimic physiological conditions, making them particularly suitable for biomedical applications. The pH of the neutral solution, e.g., close to 7, maintains the hydrogel's stability and prevents further chemical modification. The temperature of the neutral solution can also be controlled to optimize the washing and equilibration process. A temperature close to room temperature can be used although higher or lower temperatures can be used for specific applications.

The benefits of using a neutral solution (223) include ensuring the purity and biocompatibility of the hydrogel (220) by removing residual chemicals. It stabilizes the hydrogel's structure by allowing it to reach its equilibrium swelling state, preventing further swelling or shrinkage due to residual chemicals or pH imbalances. This stabilization can maintain the hydrogel's dimensional stability and mechanical integrity. Furthermore, the neutral solution prepares the hydrogel for its intended application by creating a clean and controlled environment, optimizing its performance and ensuring consistent results. This careful washing and equilibration process is useful for many applications, especially in biomedicine, where the presence of residual chemicals or unstable hydrogel properties could have adverse effects.

Variations and alternatives for implementing the neutral solution (223) provide flexibility in optimizing the hydrogel processing protocol. Different types of buffered saline solutions can be used to mimic specific physiological conditions or provide additional buffering capacity. The washing method can also be varied. Immersion of the hydrogel in the neutral solution is a common practice, but alternative methods, like spraying or perfusion, can be employed for specific hydrogel geometries or applications. The duration of the washing step can be adjusted to ensure complete removal of residual chemicals. Additional additives, like stabilizing agents or preservatives, can be incorporated into the neutral solution to further enhance the hydrogel's properties or shelf life. For instance, the addition of a preservative might be necessary for hydrogels intended for long-term storage or use.

Some embodiments for making the hydrogel (220) include treatment with a solution (224). The solution (224) in this context refers to a general liquid medium used for treating the sacrificial ionic scaffold (206) and facilitating its transformation into a hydrogel (220). This solution can encompass a wide range of compositions, including acidic, basic, or neutral solutions, each with its own specific effects on the scaffold and the resulting hydrogel. The choice of solution depends on the desired properties of the final hydrogel, such as its swelling behavior, mechanical characteristics, and stability. This versatility in solution choice allows for tailoring the hydrogel's properties to meet the specific requirements of various applications, offering a flexible and adaptable platform for hydrogel fabrication.

The functionality of the solution (224) varies depending on its composition and pH. A basic solution (221) disrupts the ionic bonds within the sacrificial ionic scaffold (206), triggering its conversion into a hydrogel. An acidic solution (222) can be used to modulate the hydrogel's properties, such as its swelling behavior and mechanical strength. A neutral solution (223) serves to wash away residual chemicals and stabilize the hydrogel's structure. The solution's interaction with the scaffold and the resulting hydrogel involves a complex interplay of chemical and physical processes. These processes include changes in charge distribution, polymer chain conformation, water absorption, and network rearrangement, all contributing to the final properties of the hydrogel.

The solution (224) can be implemented using a wide range of liquids, each with its own specific effects on the hydrogel formation process. Water, either deionized or containing specific salts, is a common choice for neutral or buffered solutions. Aqueous solutions of various acids, such as hydrochloric acid, sulfuric acid, or acetic acid, can be used for acidic solutions. Basic solutions can be prepared using alkaline substances like sodium hydroxide, potassium hydroxide, or ammonium hydroxide. The concentration of the solution can be adjusted over a broad range to control the rate and extent of the solution's interaction with the scaffold and the hydrogel. The pH of the solution, a useful parameter, can range from highly acidic to highly basic, providing a wide spectrum of options for tailoring the hydrogel's properties. The temperature of the solution can also be controlled to influence the reaction kinetics and the final characteristics of the hydrogel.

The benefits of employing a solution (224) in this process are substantial. It provides a simple and effective means of transforming the sacrificial ionic scaffold (206) into a hydrogel (220). The versatility in solution choice allows for precise control over the hydrogel's properties, adapting it to various applications. The use of a solution also facilitates a clean and controlled conversion process, minimizing the risk of contamination or structural damage to the hydrogel. This method offers improvements over conventional hydrogel fabrication techniques, which may lack the same level of control and versatility in shaping the hydrogel and tailoring its properties.

Variations and alternatives in implementing the solution (224) further expand the possibilities of hydrogel fabrication. Different solvents, such as organic solvents or mixtures of water and organic solvents, can be used for specific applications or to enhance the solubility of certain polyelectrolytes. Additives, such as crosslinking agents, stabilizing agents, or bioactive molecules, can be incorporated into the solution to modify the hydrogel's properties or introduce new functionalities. The treatment method can be adapted to accommodate different scaffold geometries and desired hydrogel properties. Immersion, spraying, or perfusion techniques can be used, each with its own advantages and limitations. The combination of different solution compositions, concentrations, pH values, temperatures, and treatment methods provides a powerful toolbox for creating hydrogels with a wide range of characteristics.

While the described process focuses on the use of a basic solution (221) for the initial transformation of the sacrificial ionic scaffold (206) into a hydrogel (220), alternative chemical triggers can be employed to initiate this conversion. For instance, specific enzymes could be used to selectively degrade the scaffold. This enzymatic approach offers high specificity and control over the degradation process, allowing for targeted modification of the scaffold and precise tuning of the hydrogel's properties. The choice of enzyme would depend on the composition of the scaffold and the desired degradation kinetics. Furthermore, external stimuli, such as temperature changes, light irradiation, or changes in ionic strength, could be used to trigger the conversion process. Temperature-sensitive polymers within the scaffold could be designed to undergo a conformational change at a specific temperature, leading to scaffold degradation and hydrogel formation. Similarly, photodegradable linkages could be incorporated into the scaffold, allowing for light-triggered conversion. These alternative triggers provide additional flexibility in the design and fabrication of hydrogels, expanding the range of achievable properties and potential applications.

The composition of the sacrificial ionic scaffold (206) itself can be further tailored to introduce additional functionalities or modify the properties of the resulting hydrogel (220). The incorporation of bioactive molecules, such as growth factors or therapeutic agents, within the scaffold can create hydrogels with inherent biological activity. These bioactive hydrogels can be used in drug delivery systems, tissue engineering scaffolds, or wound healing applications. The inclusion of nanoparticles within the scaffold can imbue the hydrogel with unique optical, magnetic, or electrical properties. These functionalized hydrogels can be employed in sensing, imaging, or actuation applications. Furthermore, the porosity and pore size distribution of the scaffold can be carefully controlled to influence the hydrogel's permeability and diffusion characteristics. This is useful for applications requiring controlled transport of molecules or cells within the hydrogel network.

The post-treatment processing of the hydrogel can also involve additional steps to further enhance its properties or adapt it to specific applications. Surface modification techniques can be employed to alter the hydrogel's surface chemistry and introduce specific functionalities. For instance, the hydrogel surface can be functionalized with cell adhesion molecules to promote cell attachment and growth in tissue engineering applications. Alternatively, the surface can be modified with antimicrobial agents to prevent bacterial colonization in wound healing applications. The hydrogel can also be coated with other materials, such as polymers or metals, to improve its mechanical strength, biocompatibility, or barrier properties. These coatings can be applied through various methods, including dip coating, spray coating, or chemical vapor deposition.

The mechanical properties of the hydrogel (220) can be further tuned by introducing additional crosslinking mechanisms or incorporating reinforcing agents within the scaffold (206). Secondary crosslinking, either chemical or physical, can increase the hydrogel's stiffness and mechanical strength, making it more resistant to deformation under stress. Reinforcing agents, such as nanofibers or microparticles, can be added to the scaffold to improve its mechanical integrity and enhance the hydrogel's load-bearing capacity. These modifications are particularly important for applications where the hydrogel is subjected to mechanical forces, such as in cartilage regeneration or as a structural component in bioengineered tissues.

The cationic poly-ammonium electrolyte (202) within the sacrificial ionic scaffold (206) can encompass a diverse range of polymeric materials. Beyond the commonly used polyethylenimine (PEI), other suitable cationic polymers include poly(allylamine hydrochloride) (PAH), chitosan, and poly(L-lysine). These polymers offer varying degrees of charge density, molecular weight, and biocompatibility, allowing for tailoring the scaffold's properties to specific applications. For example, chitosan, derived from natural sources, exhibits excellent biocompatibility and biodegradability, making it suitable for biomedical applications. PAH, with its high charge density, can form strong ionic complexes with anionic polyelectrolytes, leading to robust scaffolds. The choice of cationic polyelectrolyte will depend on factors such as the desired mechanical strength of the scaffold, its degradation rate, and its interaction with the anionic polyelectrolyte. The molecular weight of the cationic polyelectrolyte can range from 1 kDa to 1000 kDa, specifically from 5 kDa to 500 kDa, and more specifically from 10 kDa to 100 kDa. This broad range allows for control over the scaffold's viscosity, porosity, and mechanical properties.

Similarly, the anionic poly-acrylate electrolyte (208) can be chosen from a variety of anionic polymers. Poly(acrylic acid) (PAA) and its derivatives, such as poly(methacrylic acid) (PMAA), are commonly used options. Other suitable anionic polymers include alginate, carrageenan, and hyaluronic acid. These polymers offer a range of properties, including biocompatibility, biodegradability, and varying degrees of hydrophilicity. Alginate, derived from seaweed, exhibits excellent biocompatibility and can form gels in the presence of divalent cations, providing additional control over the scaffold's properties. Hyaluronic acid, a naturally occurring polysaccharide, is a major component of the extracellular matrix and exhibits excellent biocompatibility and hydration properties. The choice of anionic polyelectrolyte will depend on factors such as the desired interaction with the cationic polyelectrolyte, the desired degradation rate of the scaffold, and the intended application of the resulting hydrogel. The molecular weight of the anionic polyelectrolyte can range from 1 kDa to 1000 kDa, specifically from 5 kDa to 500 kDa, and more specifically from 10 kDa to 100 kDa. This range allows for fine-tuning of the scaffold's properties, including its viscosity, porosity, and mechanical strength.

The covalent crosslinker (207), an optional component of the additive manufacturing polyelectrolyte resin (200), can be chosen from a variety of crosslinking agents. Polyethylene glycol diacrylate (PEGDA) is a commonly used option due to its biocompatibility and tunable crosslinking density. Other suitable crosslinkers include N,N′-methylenebisacrylamide (MBA), glutaraldehyde, and genipin. MBA is a widely used crosslinker for acrylamide-based hydrogels and provides robust crosslinking. Glutaraldehyde is a commonly used crosslinker for proteins and other biomolecules, offering high crosslinking efficiency. Genipin, a naturally occurring crosslinker derived from gardenia fruit, exhibits excellent biocompatibility and low toxicity. The choice of crosslinker will depend on the specific polyelectrolytes used in the scaffold, the desired degree of crosslinking, and the intended application of the hydrogel. The concentration of the crosslinker can range from 0.1% to 10% by weight, specifically from 0.5% to 5% by weight, and more specifically from 1% to 2% by weight, relative to the total weight of the resin. This allows for control over the crosslinking density and the resulting mechanical properties of the scaffold and the hydrogel. The molecular weight of the crosslinker can range from 100 Da to 10,000 Da, specifically from 200 Da to 5,000 Da, and more specifically from 500 Da to 1,000 Da.

The photoinitiator (204), essential for the photopolymerization process, can be selected from a range of photoactive compounds. Diphenyl(2,4,6-trimethylbenzoyl) phosphine oxide (TPO) and phenylbis(2,4,6-trimethylbenzoyl) phosphine oxide (BAPO) are commonly used options due to their high efficiency and compatibility with various acrylate monomers. Other suitable photoinitiators include Irgacure 2959, lithium phenyl-2,4,6-trimethylbenzoylphosphinate (LAP), and camphorquinone. Irgacure 2959 is a widely used photoinitiator for acrylate and methacrylate polymerizations, offering high reactivity and good solubility in various resins. LAP is a highly efficient photoinitiator for free radical polymerization, offering excellent performance in various applications. Camphorquinone is a commonly used photoinitiator for dental resins and exhibits good biocompatibility. The choice of photoinitiator will depend on the specific acrylate monomer used, the desired curing speed, and the wavelength of the polymerizing light source. The concentration of the photoinitiator can range from 0.1% to 5% by weight, specifically from 0.5% to 2% by weight, and more specifically from 1% to 1.5% by weight, relative to the total weight of the resin. This range allows for optimization of the photopolymerization process, ensuring efficient curing while minimizing the risk of photodegradation.

The sacrificial ionic scaffold (206) can be fabricated in a wide range of sizes and dimensions, depending on the intended application of the final hydrogel (220). The scaffold's size can range from micrometers to centimeters, specifically from 10 micrometers to 5 centimeters, and more specifically from 100 micrometers to 1 centimeter. This broad range allows for the creation of hydrogels for diverse applications, from microscale devices to macroscopic implants. The scaffold's shape can also vary widely, from simple geometric shapes like cubes and cylinders to complex, biomimetic structures. Additive manufacturing techniques offer significant flexibility in designing and fabricating scaffolds with intricate shapes and features, enabling the creation of hydrogels that closely mimic the structure and function of natural tissues. The resolution of the fabrication process, which determines the minimum feature size that can be achieved, can range from 1 micrometer to 100 micrometers, specifically from 5 micrometers to 50 micrometers, and more specifically from 10 micrometers to 20 micrometers. This high resolution allows for the creation of scaffolds with fine details and complex internal architectures.

The thickness of the sacrificial ionic scaffold (206) can be tailored to meet specific application requirements. For applications requiring high surface area, thin scaffolds with thicknesses ranging from 10 micrometers to 100 micrometers can be fabricated. Thicker scaffolds, with thicknesses ranging from 100 micrometers to 1 millimeter, or even thicker, can be used for applications requiring greater mechanical robustness or controlled release of encapsulated molecules. The thickness of the scaffold also influences the diffusion of the basic solution (221) during the hydrogel formation process. Thinner scaffolds allow for faster and more uniform conversion to the hydrogel, while thicker scaffolds may require longer treatment times or specialized treatment methods to ensure complete conversion. The ability to control the scaffold's thickness provides another degree of freedom in tailoring the properties and performance of the resulting hydrogel.

The surface area of the sacrificial ionic scaffold (206) can be designed to optimize its interaction with the basic solution (221) and to control the properties of the final hydrogel (220). Scaffolds with high surface area, achieved through porous structures or complex geometries, allow for increased contact with the basic solution, promoting faster and more uniform hydrogel formation. This is particularly beneficial for applications requiring rapid conversion or homogenous hydrogel properties. The surface area also influences the hydrogel's interaction with its surrounding environment. Hydrogels with high surface area are advantageous for applications involving cell adhesion, drug delivery, or sensing, as the increased surface area promotes greater interaction with cells, molecules, or other targets.

The porosity of the sacrificial ionic scaffold (206) is a parameter that influences both the scaffold's performance and the properties of the resulting hydrogel (220). The porosity, as given by the ratio of void volume to total volume, can range from 10% to 90%, specifically from 20% to 80%, and more specifically from 30% to 70%. High porosity scaffolds offer several advantages, including increased surface area for interaction with the basic solution (221) and enhanced diffusion of nutrients and waste products within the hydrogel (220). The pore size distribution, which describes the range of pore sizes within the scaffold, can also be tailored to meet specific application requirements. For instance, scaffolds with small pore sizes are suitable for filtering small molecules or particles, while scaffolds with larger pore sizes can accommodate cell infiltration and tissue growth. The ability to control the scaffold's porosity and pore size distribution provides a powerful tool for tailoring the hydrogel's properties and performance.

The interconnectivity of the pores within the sacrificial ionic scaffold (206) plays a useful role in determining the hydrogel's (220) properties and its suitability for various applications. Highly interconnected pores facilitate the flow of liquids and the diffusion of molecules within the hydrogel, which is useful for applications like drug delivery and tissue engineering. The degree of pore interconnectivity also influences the hydrogel's mechanical properties. Scaffolds with highly interconnected pores tend to be more flexible and compliant, while scaffolds with less interconnected pores exhibit greater stiffness and mechanical strength. The interconnectivity of the pores can be controlled by adjusting the scaffold fabrication parameters, such as the printing pattern or the crosslinking density. This control over pore interconnectivity offers another avenue for tailoring the hydrogel's properties to meet the demands of specific applications. Furthermore, the surface roughness of the scaffold can be adjusted to modulate cell adhesion and other surface interactions. A rougher surface can promote cell attachment and spreading, while a smoother surface might be preferred for applications requiring minimal surface interaction.

The sacrificial ionic scaffold (206), acting as a template for the hydrogel (220), can be designed in a wide array of shapes and geometries, significantly expanding the possibilities for creating complex and functional hydrogel structures. Simple geometric shapes, such as cubes, spheres, cylinders, or disks, can be readily fabricated. These basic shapes are suitable for applications where uniform hydrogel properties and simple geometries are desired. More complex geometries, such as lattices, meshes, or biomimetic structures, can be created and offer advantages in applications requiring high surface area, controlled porosity, or specific mechanical properties. For instance, lattice structures can provide a high surface area for cell attachment and growth in tissue engineering applications, while meshes can be used for filtration or controlled drug release. Biomimetic structures, designed to mimic the architecture of natural tissues or organs, can be used to create more realistic and functional in vitro models or implants.

The internal structure of the sacrificial ionic scaffold (206) can be tailored to further control the properties and performance of the resulting hydrogel (220). Solid scaffolds provide a homogenous template for the hydrogel, resulting in uniform properties throughout the material. Porous scaffolds, with interconnected pores, allow for the diffusion of nutrients and waste products within the hydrogel, promoting cell viability and function in tissue engineering applications. The pore size, shape, and interconnectivity can be precisely controlled during scaffold fabrication, allowing for optimization of the hydrogel's permeability, mechanical properties, and interaction with its surrounding environment. For instance, scaffolds with aligned pores can guide cell growth and alignment, while scaffolds with gradient porosity can mimic the natural variations in tissue structure.

The external geometry of the sacrificial ionic scaffold (206) can be designed to match the specific requirements of the intended application. For biomedical implants, the scaffold can be shaped to conform to the contours of the surrounding tissue, promoting integration and minimizing foreign body responses. For drug delivery systems, the scaffold can be designed to encapsulate and release therapeutic agents in a controlled manner. The surface of the scaffold can be modified to enhance its interaction with cells or biomolecules, promoting cell adhesion, growth, or specific biological responses. These surface modifications can include chemical functionalization, coating with bioactive molecules, or incorporation of nanotopographical features. The versatility in scaffold geometry and surface modification provides creation of hydrogels with tailored properties and functionalities, expanding their potential applications in various fields. The ability to fabricate scaffolds with complex shapes and precisely controlled internal structures using additive manufacturing techniques offers significant advantages over conventional hydrogel processing methods, which are often limited in their ability to create intricate or customized hydrogel designs. This unique capability enables the creation of hydrogels with enhanced functionality and improved performance, offering innovative solutions for diverse applications.

The process of creating a hydrogel (220) with a precisely controlled shape begins with providing a sacrificial ionic scaffold (206). This scaffold serves as a temporary template, guiding the formation of the hydrogel and imparting its desired shape. The scaffold's composition, comprising a cationic poly-ammonium electrolyte (202) and an anionic poly-acrylate electrolyte (208) complexed together, is useful for its functionality. This ionic complexation creates a stable, yet readily dissociative structure capable of supporting the hydrogel precursor during fabrication. The choice of specific polyelectrolytes and their complexation method influence the scaffold's mechanical properties, degradation behavior, and ultimately the characteristics of the final hydrogel. The selection of appropriate cationic (202) and anionic (208) polyelectrolytes is useful for achieving the desired scaffold properties. These polyelectrolytes can be chosen based on factors such as their charge density, molecular weight, biocompatibility, and ability to form stable complexes. The complexation process itself can be carried out through various methods. Once formed, the scaffold can be further processed into specific shapes or geometries. This allows for the creation of scaffolds with intricate three-dimensional structures tailored to the desired hydrogel shape. The benefits of providing a sacrificial ionic scaffold (206) are numerous. It offers a precise template for hydrogel formation, enabling the creation of complex shapes that would be difficult or impossible to achieve through traditional hydrogel processing methods. The scaffold's temporary nature allows for its removal after hydrogel formation, leaving behind a pure hydrogel structure. The ionic nature of the scaffold facilitates its controlled degradation using a basic solution (221), ensuring a clean and efficient transition to the hydrogel. The scaffold also provides mechanical support during hydrogel fabrication, preventing deformation or collapse of the delicate hydrogel structure. Variations and alternatives exist for providing the sacrificial ionic scaffold (206). The choice of polyelectrolytes can be adapted to achieve specific scaffold properties, such as biodegradability, biocompatibility, or mechanical strength. The complexation method can be tailored to influence the scaffold's microstructure and porosity. Furthermore, the scaffold can be functionalized by incorporating additional components, such as bioactive molecules or nanoparticles, to imbue the resulting hydrogel with specific properties or functionalities.

In an embodiment, the transformation of the sacrificial ionic scaffold (206) into the desired hydrogel (220) is achieved by treating the scaffold with a basic solution (221). This treatment initiates a controlled degradation process, disrupting the ionic bonds within the scaffold and facilitating its conversion into a soft, water-swollen hydrogel. The basic solution's composition, concentration, and the treatment conditions can be optimized to ensure a clean and efficient transformation, preserving the intricate shape and structural details of the original scaffold. This method provides a precise and reproducible way to create hydrogels with complex geometries, overcoming the limitations of traditional hydrogel fabrication techniques. The treatment process involves immersing the sacrificial ionic scaffold (206) in a basic solution (221) for a predetermined period. The basic solution, typically an aqueous solution of a hydroxide salt like sodium hydroxide (NaOH) or potassium hydroxide (KOH), disrupts the ionic interactions between the cationic and anionic polyelectrolytes within the scaffold. This disruption weakens the scaffold's structure, allowing the polymer chains to relax and absorb water. As the scaffold degrades, the polymer chains become more mobile and begin to rearrange, forming the three-dimensional network characteristic of a hydrogel. The basic solution's pH, concentration, and temperature, along with the immersion time, are useful parameters that influence the rate and extent of scaffold degradation and hydrogel formation. These parameters are carefully optimized to achieve the desired hydrogel properties, such as swelling behavior, mechanical strength, and porosity.

The benefits of treating the sacrificial ionic scaffold (206) with a basic solution (221) are manifold. This method provides a simple and efficient way to convert the rigid scaffold into a soft, pliable hydrogel. The controlled degradation process ensures a clean transition, minimizing the presence of residual scaffold material in the final hydrogel product. The treatment process can be easily scaled up for large-scale production of hydrogels, making it a practical and cost-effective approach. Furthermore, the use of a basic solution allows for precise control over the hydrogel's properties by adjusting the treatment parameters, such as solution concentration, pH, temperature, and immersion time. Variations and alternatives exist for treating the sacrificial ionic scaffold (206). Different basic solutions can be employed, each with its own specific effects on the scaffold degradation and hydrogel formation. The treatment method can also be varied. Immersion is a common approach, but alternative methods, such as spraying or perfusion, can be used for specific scaffold geometries or desired hydrogel properties. The treatment conditions, including temperature and duration, can be adjusted to optimize the transformation process. Furthermore, additives, such as chelating agents or surfactants, can be incorporated into the basic solution to modify the degradation process or enhance the hydrogel's properties.

The treatment of the sacrificial ionic scaffold (206) with a basic solution (221) represents an innovation in hydrogel fabrication. This method provides a controlled and efficient way to transform the rigid scaffold into a soft hydrogel, preserving the intricate shape and structural details of the original template. The ability to tailor the hydrogel's properties by adjusting the treatment parameters makes this approach highly versatile and adaptable to diverse applications. This method offers improved functionality by enabling the creation of complex hydrogel shapes not readily achievable through traditional processing techniques. It enhances performance by allowing for precise control over the transformation process and by minimizing residual scaffold material in the final product. The novelty of this method stems from the use of a sacrificial ionic scaffold and a controlled chemical treatment to create complex hydrogel structures. This provides a practical and useful solution to the limitations of conventional hydrogel fabrication methods, demonstrating clear utility and non-obviousness.

One aspect of making the hydrogel (220) involves the formulation of an additive manufacturing polyelectrolyte resin (200). This resin, a balanced mixture of components, serves as the precursor for the scaffold, ultimately dictating its properties and the characteristics of the final hydrogel (220). The resin comprises a cationic poly-ammonium electrolyte (202), an anionic organic acrylate monomer (203), a photoinitiator (204), and a chemical modifier (218). Each component plays a specific role in the scaffold formation process, contributing to the resin's photopolymerizable nature, its ability to form stable ionic complexes, and its ultimate transformation into a hydrogel.

The implementation of providing the additive manufacturing polyelectrolyte resin (200) involves selection and combination of its constituent components. The cationic poly-ammonium electrolyte (202) and the anionic organic acrylate monomer (203) are chosen based on their ability to form stable ionic complexes, which is essential for the scaffold's structural integrity. The photoinitiator (204) is selected based on its compatibility with the acrylate monomer and its efficiency in initiating the photopolymerization reaction. The chemical modifier (218) can be chosen from a variety of compounds, such as photoabsorbers (215) or ion dispersion solvents (205) containing an organic reactive diluent (216). The photoabsorber enhances the resin's light absorption properties, improving the efficiency of the photopolymerization process. The ion dispersion solvent helps to disperse the polyelectrolytes and control the viscosity of the resin, facilitating its processing and shaping. The concentrations of each component in the resin can be optimized to achieve the desired scaffold properties, such as its mechanical strength, porosity, and degradation rate.

The benefits of this formulated resin are numerous. The combination of the cationic and anionic polyelectrolytes allows for the formation of a stable ionic scaffold that can be readily converted into a hydrogel. The inclusion of a photoinitiator enables the use of additive manufacturing techniques, such as vat photopolymerization or stereolithography, for creating scaffolds with intricate three-dimensional shapes. The chemical modifier further enhances the fabrication process by improving light absorption or controlling resin viscosity. This multifaceted approach offers significant advantages over conventional hydrogel fabrication methods, providing greater control over the hydrogel's shape, structure, and properties.

Variations and alternatives exist for the resin formulation. Different cationic and anionic polyelectrolytes can be chosen based on their specific properties and the desired characteristics of the hydrogel. Alternative photoinitiators and chemical modifiers can be employed to optimize the photopolymerization process or to introduce additional functionalities. The concentrations of each component can be adjusted to fine-tune the resin's properties and the resulting scaffold's characteristics. Furthermore, additional components, such as crosslinking agents or bioactive molecules, can be incorporated into the resin to further modify the hydrogel's properties or introduce therapeutic functionalities.

The provision of a formulated additive manufacturing polyelectrolyte resin (200) offers precise control over the scaffold's composition and properties, enabling the creation of hydrogels with tailored characteristics. The combination of ionic complexation, photopolymerization, and chemical modification provides a unique and versatile platform for hydrogel fabrication. The resin's adaptability to various additive manufacturing techniques further enhances its utility, enabling the creation of complex hydrogel shapes not readily achievable with conventional methods.

The transformation the liquid additive manufacturing polyelectrolyte resin (200) into a solid sacrificial ionic scaffold (206) is initiated by subjecting the resin to polymerizing light (219). This step, referred to as photopolymerization, uses light energy to trigger a chemical reaction that converts the anionic organic acrylate monomer (203) within the resin into a solid anionic poly-acrylate electrolyte (208). This polymerization process forms the backbone of the scaffold, creating a stable, interconnected network of polymer chains. The choice of light source, its intensity, and the exposure time are carefully controlled to optimize the polymerization reaction and achieve the desired scaffold properties.

The implementation of subjecting the resin (200) to polymerizing light (219) involves selecting an appropriate light source and controlling the exposure conditions. The light source is chosen based on its wavelength, which matches the absorption spectrum of the photoinitiator (204) present in the resin. Common light sources include ultraviolet (UV) lamps, lasers, or light-emitting diodes (LEDs). The intensity of the light source influences the rate of polymerization, while the exposure time determines the extent of monomer conversion. These parameters are balanced to ensure efficient polymerization without causing excessive heat generation or photodegradation of the resin. The exposure process can be carried out in various configurations, such as flood exposure, where the entire resin surface is illuminated simultaneously, or patterned exposure, where the light is selectively directed to specific areas of the resin using masks or projection systems. Patterned exposure allows for the creation of scaffolds with intricate three-dimensional shapes and complex internal architectures, taking full advantage of the capabilities of additive manufacturing techniques.

The benefits of using polymerizing light (219) are myriad. Photopolymerization offers a rapid and efficient way to convert the liquid resin (200) into a solid scaffold (206). The process can be precisely controlled by adjusting the light intensity and exposure time, allowing for fine-tuning of the scaffold's properties. The use of patterned light exposure enables the fabrication of scaffolds with complex shapes and internal structures, which would be challenging or impossible to achieve with conventional molding or casting techniques. This spatial control over scaffold geometry is useful for creating hydrogels with tailored functionalities and performance characteristics.

Variations and alternatives exist for the photopolymerization process. Different light sources and exposure methods can be employed depending on the specific resin formulation and the desired scaffold properties. For example, two-photon polymerization, a high-resolution additive manufacturing technique, can be used to create scaffolds with sub-micron features. The photoinitiator (204) can also be varied to optimize the polymerization process for different light sources or wavelengths. Furthermore, the addition of photosensitizers can enhance the resin's light absorption properties, improving the efficiency of polymerization.

Subjecting the additive manufacturing polyelectrolyte resin (200) to polymerizing light (219) is a useful step in the fabrication of the sacrificial ionic scaffold (206). This precisely controlled photopolymerization process enables the creation of scaffolds with intricate shapes and tailored properties, laying the foundation for the fabrication of complex, functional hydrogels. The use of light as a trigger for polymerization offers significant advantages over traditional methods, providing spatial control over scaffold formation and enabling the use of additive manufacturing techniques. The versatility of this process, combined with the ability to fine-tune the polymerization parameters, makes it a powerful tool for creating advanced hydrogel materials.

The formation of the sacrificial ionic scaffold (206) relies on the complexation between the cationic poly-ammonium electrolyte (202) and the anionic poly-acrylate electrolyte (208). This complexation process, driven by electrostatic interactions between the oppositely charged polyelectrolytes, results in the formation of a stable, interconnected network that serves as the structural backbone of the scaffold. The strength and nature of these ionic interactions are useful for determining the scaffold's mechanical properties, its degradation behavior in the presence of a basic solution (221), and ultimately the characteristics of the final hydrogel (220). This controlled complexation process allows for the creation of scaffolds with tailored properties, optimized for specific applications.

Complexing the cationic and anionic polyelectrolytes involves bringing the two polyelectrolyte solutions into contact under controlled conditions. Simple mixing of the solutions is a common approach, where the polyelectrolytes spontaneously complex due to their electrostatic attraction. The complexation process can be influenced by factors such as the concentration and ratio of the polyelectrolytes, the pH of the solution, and the presence of other ions or additives. Alternative methods of complexation include layer-by-layer deposition, where alternating layers of cationic and anionic polyelectrolytes are deposited onto a substrate, or controlled precipitation, where the polyelectrolytes are slowly precipitated from solution under carefully controlled conditions. These methods offer greater control over the scaffold's microstructure and morphology, allowing for the creation of scaffolds with tailored properties.

The formation of a stable ionic complex provides the structural integrity for the scaffold to maintain its shape and support the hydrogel precursor during fabrication. The reversible nature of the ionic interactions allows for controlled degradation of the scaffold using a basic solution, enabling a clean and efficient transition to the hydrogel. The complexation process can be readily adapted to different polyelectrolyte combinations, allowing for the creation of scaffolds with tailored properties. This flexibility is useful for optimizing the scaffold's performance and the resulting hydrogel's characteristics for diverse applications.

Variations and alternatives exist for the complexation process. The choice of cationic and anionic polyelectrolytes can be varied to achieve specific scaffold properties, such as biocompatibility, biodegradability, or mechanical strength. The complexation method itself can be adapted to influence the scaffold's microstructure, porosity, and surface properties. The addition of crosslinking agents or other additives during the complexation process can further modify the scaffold's characteristics and the properties of the resulting hydrogel.

The complexation of the cationic poly-ammonium electrolyte (202) with the anionic poly-acrylate electrolyte (208) is a fundamental step in the formation of the sacrificial ionic scaffold (206). This controlled complexation process, driven by electrostatic interactions, creates a stable and readily degradable structure, enabling the fabrication of hydrogels with complex shapes and tailored properties. The ability to adjust the complexation parameters, such as polyelectrolyte choice and complexation method, provides flexibility in optimizing the scaffold's performance for specific applications. This innovative approach offers significant advantages over conventional hydrogel fabrication methods, opening new avenues for the creation of advanced hydrogel materials.

Neutralizing the hydrogel (220) after treatment with the basic solution (221) refines the hydrogel's properties and prepares the hydrogel (220) for its intended application. The basic solution, while useful for converting the sacrificial ionic scaffold (206) into a hydrogel, can leave behind residual alkalinity that may be undesirable for certain applications, particularly those involving biological systems. Neutralization ensures that the hydrogel's pH is adjusted to a biocompatible range, minimizing potential adverse effects on cells or tissues. This process also helps to stabilize the hydrogel's structure and optimize its performance characteristics.

Neutralizing the hydrogel (220) can involve washing the hydrogel with a neutral solution (223), such as deionized water or a buffered saline solution. The neutral solution effectively removes residual basic solution and any other byproducts of the scaffold degradation process. The washing process can be carried out through various methods, including immersion, spraying, or perfusion, depending on the hydrogel's geometry and the desired level of neutralization. The pH of the neutral solution is controlled to ensure complete neutralization without introducing acidity. The temperature and duration of the washing can be optimized to ensure thorough removal of residual base without compromising the hydrogel's structural integrity. Adjusting the pH to a neutral range enhances the hydrogel's biocompatibility, making it more suitable for applications involving cells or tissues. Neutralization also helps to stabilize the hydrogel's structure, preventing further swelling or shrinkage due to pH imbalances. This stability is useful for maintaining the hydrogel's dimensional accuracy and mechanical properties, ensuring consistent and reliable performance in its intended application.

Variations and alternatives exist for neutralizing the hydrogel (220). Different neutral solutions can be employed, such as phosphate-buffered saline (PBS) or other buffered solutions that mimic physiological conditions. The washing method can also be varied to accommodate different hydrogel geometries or application requirements. The addition of buffering agents to the neutral solution can further enhance pH stability and prevent fluctuations that might affect the hydrogel's properties. Neutralizing the hydrogel (220) represents a refinement in the hydrogel fabrication process. This step ensures the removal of residual base, adjusts the pH to a biocompatible range, and stabilizes the hydrogel's structure. These improvements enhance the hydrogel's functionality, particularly in biomedical applications, where biocompatibility and stability are paramount.

Immersing the sacrificial ionic scaffold (206) in the basic solution (221) for a specific duration, such as at least 16 hours, ensures the complete and uniform conversion of the scaffold into a hydrogel (220). The immersion time allows for thorough penetration of the basic solution into the scaffold's structure, facilitating the disruption of ionic bonds and the subsequent absorption of water. This immersion process ensures consistent and reproducible results, producing hydrogels with uniform properties and predictable behavior. The specific duration of immersion can be adjusted based on the scaffold's composition, size, and geometry, as well as the desired characteristics of the final hydrogel. Immersing the sacrificial ionic scaffold (206) in the basic solution (221) can involve controlling the immersion time and the conditions of the immersion process. The scaffold is typically immersed in a sufficient volume of basic solution to ensure complete coverage and prevent localized variations in pH or concentration. The container holding the scaffold and the basic solution can be sealed to minimize evaporation and maintain a constant solution concentration throughout the immersion period. The temperature of the solution can be controlled to influence the reaction kinetics and the rate of scaffold degradation. Gentle agitation or stirring of the solution can further enhance the uniformity of the treatment process, ensuring even penetration of the basic solution into the scaffold's structure.

Immersing the scaffold for a specific duration, such as at least 16 hours, ensures that the basic solution has sufficient time to penetrate the scaffold's entire structure and disrupt all the ionic bonds holding it together. This complete disruption facilitates uniform conversion of the scaffold into a hydrogel, minimizing the presence of residual scaffold material or variations in hydrogel properties. The controlled immersion process also enhances the reproducibility of the hydrogel fabrication method, ensuring consistent results across multiple experiments or production runs.

Variations and alternatives exist for the immersion process. The immersion time can be adjusted based on the specific scaffold and desired hydrogel properties. Shorter immersion times may be sufficient for thin or highly porous scaffolds, while thicker or denser scaffolds may require longer immersion times. Alternative treatment methods, such as spraying or perfusion, can be employed for scaffolds with complex geometries or for applications requiring localized hydrogel formation. The composition and concentration of the basic solution can also be varied to control the rate of scaffold degradation and the properties of the resulting hydrogel.

Immersing the sacrificial ionic scaffold (206) in the basic solution (221) for a selected duration ensures complete and uniform scaffold degradation, resulting in hydrogels with consistent and predictable properties. The ability to adjust the immersion time and other treatment parameters provides flexibility in tailoring the hydrogel's characteristics for specific applications. This precise and reproducible method offers significant advantages over conventional hydrogel processing techniques, enabling the creation of high-quality hydrogel materials with enhanced functionality and performance.

Soaking the hydrogel (220) in water after treatment with the basic solution (221) removes residual base and allows the hydrogel to fully swell and equilibrate. The basic solution, while useful for initiating the transformation of the sacrificial ionic scaffold (206) into a hydrogel, can leave behind residual alkalinity that may be undesirable for certain applications. Soaking the hydrogel in water effectively washes away these residual chemicals, ensuring the hydrogel's biocompatibility and optimizing its performance characteristics. This soaking step also allows the hydrogel to reach its equilibrium swelling state, which is useful for maintaining its dimensional stability and mechanical properties.

Soaking the hydrogel (220) in water involves immersing the hydrogel in a sufficient volume of water or an appropriate aqueous solution, such as a buffered saline solution. The soaking process can be carried out at room temperature or at a controlled temperature, depending on the specific hydrogel and the desired properties. The duration of the soaking step can range from a few hours to several days, depending on the hydrogel's size, porosity, and the extent of residual base. The water can be changed periodically to ensure efficient removal of residual chemicals and to maintain a constant pH environment. Gentle agitation or stirring of the water can further enhance the washing process and promote uniform swelling of the hydrogel.

Soaking the hydrogel (220) in water removes residual basic solution (221) and other byproducts of the scaffold degradation process, ensuring the hydrogel's purity and biocompatibility. Soaking in water also allows the hydrogel to reach its equilibrium swelling state, stabilizing its structure and preventing further swelling or shrinkage due to pH imbalances. This stabilization is useful for maintaining the hydrogel's dimensional stability and ensuring consistent performance. Furthermore, the soaking step can be used to introduce specific additives or bioactive molecules into the hydrogel network. By soaking the hydrogel in a solution containing these components, they can diffuse into the hydrogel matrix, imbuing the hydrogel with specific properties or functionalities.

Variations and alternatives exist for the soaking process. The soaking solution can be varied to optimize the hydrogel's properties or to introduce specific functionalities. For example, buffered saline solutions can be used to mimic physiological conditions or to provide additional pH control. The soaking temperature and duration can be adjusted to tailor the hydrogel's swelling behavior and mechanical properties. The soaking process can also be combined with other post-treatment methods, such as surface modification or sterilization, to further enhance the hydrogel's performance or adapt it for specific applications.

Adjusting the pH of the water during the soaking process provide fine-tuning the degree of swelling of the hydrogel (220). The pH of the surrounding environment significantly influences the hydrogel's swelling behavior due to the presence of ionizable groups within its polymer network. By controlling the pH of the soaking water, the electrostatic interactions within the hydrogel network can be manipulated, leading to predictable and controllable changes in swelling. This pH-sensitive swelling behavior allows for precise tailoring of the hydrogel's properties, such as its porosity, mechanical characteristics, and drug release kinetics, making it a highly adaptable material for diverse applications. Adjusting the pH of the water involves soaking the hydrogel (220) in aqueous solutions with varying pH values. Acidic solutions, with a pH below 7, can protonate ionizable groups within the hydrogel network, reducing electrostatic repulsion between polymer chains and leading to a decrease in swelling. Basic solutions, with a pH above 7, can deprotonate ionizable groups, increasing electrostatic repulsion and promoting swelling. The specific pH value of the soaking solution is chosen based on the desired degree of swelling and the properties of the hydrogel's polymer network. Buffer solutions can be employed to maintain a stable pH during the soaking process, ensuring consistent and reproducible results. The temperature and duration of the soaking process can also be adjusted to further fine-tune the hydrogel's swelling behavior.

Adjusting the pH of the water provides an effective control over the hydrogel's swelling behavior, which is a useful property that influences its performance in various applications. For example, in drug delivery applications, the hydrogel's swelling can be tuned to control the rate of drug release. In tissue engineering applications, the hydrogel's swelling can be adjusted to match the mechanical properties of the surrounding tissue, promoting integration and minimizing foreign body responses. The ability to precisely control swelling also allows for the creation of hydrogels with tailored porosity, influencing their permeability and diffusion characteristics.

Variations and alternatives exist for adjusting the pH of the water. Different acids and bases can be used to create soaking solutions with varying pH values. The soaking method can also be varied. Immersion is a common approach, but alternative methods, like spraying or perfusion, can be used for specific hydrogel geometries or applications requiring localized swelling control. The addition of salts or other ionic species to the soaking solution can further influence the hydrogel's swelling behavior by altering the ionic strength of the surrounding environment.

Adjusting the pH of the water during the soaking process represents a valuable tool for tailoring the hydrogel's properties. This method provides precise control over the hydrogel's swelling behavior, enabling the creation of hydrogels with optimized characteristics for specific applications.

The temperature at which the various process steps are carried out can influence the kinetics of the reactions and the properties of the resulting hydrogel (220). The photopolymerization of the additive manufacturing polyelectrolyte resin (200) can be performed at room temperature although higher or lower temperatures may be used to control the polymerization rate and the final properties of the sacrificial ionic scaffold (206). The treatment of the scaffold with the basic solution (221) can be performed at temperatures ranging from 4° C. to 60° C., specifically from 10° C. to 40° C., and more specifically from 20° C. to 30° C. Lower temperatures can slow down the degradation process, allowing for finer control over the hydrogel formation, and higher temperatures can accelerate the conversion. The soaking of the hydrogel in water can also be performed at varying temperatures to influence its swelling behavior and equilibration rate. The ability to control the temperature at each process step provides for tailoring the hydrogel's properties and optimizing its performance for specific applications.

The duration of each process step can be adjusted to fine-tune the properties of the hydrogel (220). The exposure time of the resin (200) to polymerizing light (219) can range from a few seconds to several minutes, depending on the light intensity, the photoinitiator used, and the desired degree of polymerization. The immersion time of the scaffold (206) in the basic solution (221) can range from a few hours to several days, depending on the scaffold's composition, size, and the desired extent of degradation. The soaking time of the hydrogel in water can also be varied to optimize its swelling and equilibration. These adjustable time parameters provide additional flexibility in controlling the hydrogel fabrication process and tailoring the final product's characteristics.

The concentration of the basic solution (221) used to treat the sacrificial ionic scaffold (206) plays a role in determining the rate of scaffold degradation and the properties of the resulting hydrogel (220). Higher concentrations of base generally lead to faster degradation and the formation of hydrogels with higher swelling ratios. Lower concentrations can provide finer control over the degradation process and may be useful for creating hydrogels with specific mechanical properties or controlled release profiles. The concentration of the basic solution can range from 0.1 M to 2.0 M, specifically from 0.2 M to 1.5 M, and more specifically from 0.5 M to 1.0 M. This broad range allows for tailoring the degradation kinetics and the resulting hydrogel properties.

The pH of the basic solution (221) is another parameter that influences the hydrogel formation process. The pH can range from 8 to 14, specifically from 9 to 13, and more specifically from 10 to 12. A higher pH generally leads to faster scaffold degradation and increased hydrogel swelling. The pH also influences the charge state of the polyelectrolytes within the scaffold and the hydrogel, which can affect their interactions with other molecules or surfaces. Careful control over the pH of the basic solution is essential for creating hydrogels with desired properties and functionalities.

The atmosphere under which the various process steps are carried out can also influence the hydrogel's (220) properties and stability. The photopolymerization of the resin (200) can be performed in an inert atmosphere, such as nitrogen or argon, to prevent oxygen inhibition of the polymerization reaction. The treatment of the scaffold (206) with the basic solution (221) and the subsequent soaking of the hydrogel in water can be performed in air or in an inert atmosphere, depending on the sensitivity of the materials to oxygen or other atmospheric components. For hydrogels intended for biomedical applications, sterile conditions may be involved during certain processing steps to prevent contamination. The ability to control the atmospheric conditions provides additional flexibility in optimizing the hydrogel fabrication process and ensuring the quality and stability of the final product.

In an embodiment, a process for making a hydrogel (220) from a sacrificial ionic scaffold (206) comprises providing a sacrificial ionic scaffold (206) comprising a cationic poly-ammonium electrolyte (202) and an anionic poly-acrylate electrolyte (208) complexed together; and treating the sacrificial ionic scaffold (206) with a solution to form the hydrogel (220). In an embodiment, the solution is a basic solution. In an embodiment, the basic solution has a pH greater than 12. In an embodiment, the solution is an acidic solution. In an embodiment, the acidic solution has a pH less than 7. In an embodiment, the solution is a neutral solution. In an embodiment, the neutral solution has a pH of approximately 7. In an embodiment, the process further comprises a second treating step of soaking the hydrogel (220) in a solution having a different pH than the solution used in the treating step. In an embodiment, the sacrificial ionic scaffold (206) is formed by the process of claim 2. In an embodiment, treating the sacrificial ionic scaffold (206) comprises immersing the sacrificial ionic scaffold (206) in the solution for a predetermined period of time.

Making a hydrogel (220) from a sacrificial ionic scaffold (206) offers a versatile and precise method for fabricating hydrogels with controlled shapes and properties, overcoming the limitations of traditional hydrogel processing techniques. The process can begin by providing a sacrificial ionic scaffold (206), which serves as a template for the final hydrogel structure. This scaffold comprises a cationic poly-ammonium electrolyte (202) and an anionic poly-acrylate electrolyte (208) complexed together through ionic interactions. The specific choice of polyelectrolytes dictates the scaffold's properties, such as its mechanical strength, degradation rate, and biocompatibility. This pre-formed scaffold offers a distinct advantage by establishing a well-defined, three-dimensional template for the hydrogel, enabling precise control over its shape and dimensions.

A subsequent step involves treating the sacrificial ionic scaffold (206) with a solution (224) to form the hydrogel (220). This treatment triggers a transformation in the scaffold, converting it from a rigid, ionically crosslinked structure into a soft, water-swollen hydrogel. The solution (224) used for this treatment can be tailored to achieve specific hydrogel properties. A basic solution (221) disrupts the ionic bonds within the scaffold, facilitating its conversion into a hydrogel. An acidic solution (222) can be used to modulate the hydrogel's swelling behavior and mechanical properties. A neutral solution (223) serves to wash away residual chemicals and stabilize the hydrogel's structure. This versatility in solution choice allows for fine-tuning of the hydrogel's characteristics, making it adaptable to a wide range of applications.

The process provides a novel and effective approach to hydrogel fabrication. The use of a sacrificial ionic scaffold allows for precise control over the hydrogel's shape, while the treatment with a tailored solution facilitates a controlled transformation into the desired hydrogel material. This method offers significant advantages over conventional hydrogel processing techniques, which often struggle to achieve complex shapes and precise control over material properties. The ability to customize the scaffold's composition and the treatment solution further enhances the versatility and utility of this process, making it a valuable tool for creating advanced hydrogel materials. The method offers improved functionality by enabling the fabrication of hydrogels with intricate shapes and tailored properties. This approach enhances performance by providing a simple yet precise method for controlling the hydrogel formation process. The ability to create hydrogels with specific properties and functionalities has clear utility in diverse applications, from biomedicine to materials science.

In an embodiment, the solution (224) used to treat the sacrificial ionic scaffold (206) is a basic solution (221). This basic solution, characterized by a pH greater than 7, effectively disrupts the ionic bonds within the scaffold, facilitating its conversion into a hydrogel (220). The specific pH of the basic solution can be further defined as greater than 12, ensuring rapid and efficient scaffold degradation. Alternatively, an acidic solution (222) can be employed, having a pH less than 7. This acidic solution can be used to modulate the hydrogel's properties after its initial formation from the scaffold. The pH of the acidic solution can be further specified as less than 7, providing a wide range of acidity for tailoring the hydrogel's characteristics. In another embodiment, a neutral solution (223), with a pH of approximately 7, can be used. This neutral solution is particularly useful for washing away residual chemicals and stabilizing the hydrogel after its formation or subsequent treatments. A further refinement involves a second treating step, where the hydrogel (220) is soaked in a solution with a different pH than the initial treatment solution. This second treatment allows for further fine-tuning of the hydrogel's properties, such as its swelling behavior or mechanical strength. This two-step treatment process provides greater control over the final hydrogel material.

In yet another embodiment, the sacrificial ionic scaffold (206) is formed using a specific process involving a photopolymerizable resin (200). This resin comprises a cationic poly-ammonium electrolyte (202), an anionic organic acrylate monomer (203), a photoinitiator (204), and a chemical modifier (218). The resin is subjected to polymerizing light (219) to form the anionic poly-acrylate electrolyte (208), which then complexes with the cationic polyelectrolyte to create the scaffold. This method offers precise control over the scaffold's composition and structure, enabling the creation of scaffolds with tailored properties. The treatment of the sacrificial ionic scaffold (206) with the solution can involve immersing the scaffold in the solution for a predetermined period. This controlled immersion ensures complete and uniform treatment of the scaffold, leading to consistent and reproducible hydrogel formation. The immersion time can be optimized based on the scaffold's properties and the desired characteristics of the hydrogel.

These variations in solution composition, pH, and treatment methods provide versatility for tailoring the properties of the resulting hydrogel. The use of a basic solution ensures efficient scaffold degradation and hydrogel formation. The option of using acidic or neutral solutions allows for further modification and stabilization of the hydrogel's properties. The two-step treatment process and the controlled immersion method offer additional control over the hydrogel fabrication process, enhancing its precision and reproducibility. The specific process for forming the sacrificial ionic scaffold from a photopolymerizable resin enables the creation of scaffolds with tailored properties, further expanding the range of achievable hydrogel characteristics.

The properties of the hydrogel (220) can be further tailored by incorporating additives into the sacrificial ionic scaffold (206) or the treatment solutions. These additives can include reinforcing agents, such as nanoparticles or fibers, to enhance the hydrogel's mechanical strength and stability. Bioactive molecules, such as growth factors or therapeutic agents, can be incorporated to create hydrogels with specific biological functions. Porosity-inducing agents can be added to control the hydrogel's pore size and interconnectivity, influencing its permeability and diffusion characteristics. The choice and concentration of additives will depend on the specific application and the desired properties of the hydrogel.

The treatment of the sacrificial ionic scaffold with the solution can be performed using various methods beyond simple immersion. Spraying or coating the scaffold with the solution can be advantageous for scaffolds with complex geometries or for applications requiring localized hydrogel formation. Perfusion, where the solution is circulated through the scaffold, can enhance the uniformity of the treatment and reduce processing time. These alternative treatment methods provide flexibility in adapting the process to different scaffold designs and application requirements.

Post-treatment processing of the hydrogel can involve additional steps to further optimize its properties or adapt it for specific applications. Washing the hydrogel with a neutral solution removes residual chemicals and stabilizes its structure. Surface modification techniques, such as chemical functionalization or coating, can be used to alter the hydrogel's surface properties and enhance its biocompatibility or interaction with other materials. Sterilization methods, like autoclaving or gamma irradiation, are essential for biomedical applications. The hydrogel can also be further processed into specific shapes or forms using techniques like molding, cutting, or bonding.

The rate of hydrogel formation can be controlled by adjusting the concentration and temperature of the treatment solution. Higher concentrations and temperatures generally lead to faster scaffold degradation and hydrogel formation. Lower concentrations and temperatures can provide finer control over the process and may be preferred for creating hydrogels with specific properties. The reaction time can also be adjusted to achieve the desired degree of conversion.

The swelling behavior of the hydrogel can be further modulated by varying the ionic strength of the soaking solution. Higher ionic strength solutions can reduce hydrogel swelling due to osmotic effects, while lower ionic strength solutions can promote swelling. This control over swelling allows for fine-tuning of the hydrogel's porosity, mechanical properties, and drug release kinetics.

The process commences with providing a sacrificial ionic scaffold (206), a useful element serving as a temporary template for the hydrogel (220). This scaffold, formed through the complexation of a cationic poly-ammonium electrolyte (202) and an anionic poly-acrylate electrolyte (208), possesses a unique combination of stability and dissolvability. The ionic interactions between the polyelectrolytes create a robust structure capable of maintaining a predefined shape, while the inherent reversibility of these interactions allows for the scaffold's controlled removal after hydrogel formation. The choice of specific polyelectrolytes influences the scaffold's mechanical properties, degradation behavior, and ultimately, the characteristics of the final hydrogel product. This initial step of providing a pre-shaped scaffold is useful for achieving precise control over the hydrogel's geometry and architecture. Implementing this step involves selection of the cationic (202) and anionic (208) polyelectrolytes based on their respective properties and desired interactions. Factors to consider include charge density, molecular weight, biocompatibility, and the ability to form stable ionic complexes. The complexation process can be achieved through various methods, including simple mixing of polyelectrolyte solutions, layer-by-layer deposition techniques, or controlled precipitation. The chosen method influences the scaffold's microstructure, porosity, and mechanical strength. The formed scaffold can then be further processed into specific shapes and geometries using techniques like molding, casting, or additive manufacturing, enabling the creation of intricate three-dimensional structures.

Providing the sacrificial ionic scaffold (206) establishes a well-defined template for hydrogel formation, allowing for precise control over the hydrogel's final shape and dimensions. The scaffold's temporary nature facilitates its removal after hydrogel formation, leaving behind a pure hydrogel structure free from residual scaffold material. The ionic interactions within the scaffold enable controlled degradation using a solution, providing a clean and efficient transition to the hydrogel. Moreover, the scaffold offers mechanical support during hydrogel fabrication, preventing deformation or collapse of the nascent hydrogel structure.

Variations and alternatives exist for providing the sacrificial ionic scaffold (206). The specific polyelectrolytes used can be tailored to achieve desired scaffold properties, such as biodegradability, biocompatibility, or increased mechanical strength. Different complexation methods can be employed to control the scaffold's microstructure and porosity. Alternative fabrication techniques, like electrospinning or freeze-drying, can create scaffolds with unique architectures. Furthermore, the scaffold can be functionalized by incorporating additives, such as bioactive molecules or nanoparticles, to imbue the resulting hydrogel with specific properties or functionalities. The dimensions of the scaffold can range from micrometers to centimeters, specifically from 10 micrometers to 5 centimeters, and more specifically from 100 micrometers to 1 centimeter, accommodating a wide range of applications.

The transformation of the sacrificial ionic scaffold (206) into the desired hydrogel (220) is achieved by treating the scaffold with a selected solution (224). This treatment initiates a controlled process that disrupts the scaffold's structure, allowing it to absorb water and transition into a soft, pliable hydrogel. The choice of solution plays a useful role in determining the properties of the final hydrogel product. The solution's composition, pH, and the treatment conditions are tailored to achieve specific hydrogel characteristics, such as swelling behavior, mechanical strength, and porosity. This controlled transformation process, facilitated by the solution, offers significant advantages over conventional hydrogel fabrication methods, enabling the creation of hydrogels with precisely defined properties and complex geometries.

In an embodiment, the treatment involves immersing the sacrificial ionic scaffold (206) in the solution (224) for a predetermined period. The solution can be a basic solution (221), an acidic solution (222), or a neutral solution (223), each with its own specific effect on the scaffold and the resulting hydrogel. A basic solution disrupts the ionic bonds within the scaffold, facilitating its conversion into a hydrogel. An acidic solution can modulate the hydrogel's swelling and mechanical properties. A neutral solution washes away residual chemicals and stabilizes the hydrogel structure. The concentration, pH, and temperature of the solution, as well as the immersion time, are carefully controlled to achieve the desired transformation and hydrogel properties. The treatment can also be performed using alternative methods, such as spraying or coating the scaffold with the solution, or using a perfusion system to circulate the solution through the scaffold.

Treating the sacrificial ionic scaffold (206) with a solution offers provides effective conversion of the rigid scaffold into a soft hydrogel. The controlled nature of the transformation process minimizes damage to the hydrogel's structure and ensures a clean transition, reducing the presence of residual scaffold material. The versatility in solution choice allows for fine-tuning of the hydrogel's properties, enabling the creation of hydrogels with tailored characteristics for various applications. This adaptability makes this method particularly attractive for creating hydrogels with specific swelling behaviors, mechanical properties, or biocompatibilities.

Variations and alternatives exist for the treatment process. The composition and concentration of the solution can be adjusted to control the rate of scaffold degradation and hydrogel formation. Different treatment methods, such as spraying, perfusion, or vapor deposition, can be employed for specific scaffold geometries or desired hydrogel properties. The treatment conditions, including temperature, pressure, and duration, can be optimized to achieve the desired transformation and hydrogel characteristics. Furthermore, additives, such as crosslinking agents, bioactive molecules, or nanoparticles, can be incorporated into the solution to further modify the hydrogel's properties or introduce new functionalities.

Introducing a second treating step of soaking the hydrogel (220) in a solution with a different pH than the initial treatment solution offers a refined approach to tailoring the hydrogel's properties and optimizing its performance. This second soaking step allows for further modulation of the hydrogel's characteristics, such as its swelling behavior, mechanical strength, and responsiveness to external stimuli. By carefully selecting the pH of the second soaking solution, the hydrogel's internal structure and surface properties can be fine-tuned, expanding the range of achievable properties and enabling the creation of hydrogels with enhanced functionalities. This sequential treatment approach provides customizing hydrogel materials for diverse applications.

In an embodiment, the second treating step involves immersing the hydrogel (220) in a solution (224) with a pH different from that of the initial treatment solution. The choice of pH for the second soaking solution depends on the desired effect on the hydrogel's properties. For instance, if the initial treatment involved a basic solution (221) to induce swelling, a subsequent soak in a neutral or slightly acidic solution (222) can be used to reduce swelling and stabilize the hydrogel's structure. Conversely, if the initial treatment involved an acidic solution to reduce swelling, a subsequent soak in a basic solution can be used to increase swelling and create a more porous hydrogel. The concentration and composition of the second soaking solution, along with the temperature and duration of the soaking process, are carefully controlled to achieve the desired modification of the hydrogel's properties.

The second treating step provides fine-tuning the hydrogel's properties after its initial formation, expanding the range of achievable characteristics. This sequential treatment approach allows for greater control over the hydrogel's swelling behavior, mechanical properties, and responsiveness to external stimuli, enabling the creation of hydrogels with enhanced functionalities. For example, a hydrogel intended for drug delivery can be initially treated with a basic solution to promote swelling and drug loading, followed by a soak in a neutral solution to stabilize its structure and control drug release kinetics.

Variations and alternatives exist for implementing the second treating step. The pH of the second soaking solution can be adjusted over a wide range, from highly acidic to highly basic, depending on the desired modification of the hydrogel's properties. Different types of solutions, such as buffered solutions or solutions containing specific ions or additives, can be employed to achieve specific effects. The soaking method can also be varied. Immersion is a common approach, but alternative methods, like spraying or perfusion, can be used for specific hydrogel geometries or localized property modification. The temperature and duration of the soaking process can also be adjusted to optimize the treatment and achieve the desired hydrogel characteristics.

Immersing the sacrificial ionic scaffold (206) in the solution (224) for a predetermined period allows for the solution to thoroughly penetrate the scaffold's structure, ensuring uniform interaction with the polyelectrolytes and facilitating a complete and consistent conversion to the hydrogel. The immersion time is chosen based on several factors, including the scaffold's composition, size, and porosity, as well as the desired properties of the final hydrogel. This precise control over the immersion process ensures reproducible results and allows for tailoring the hydrogel's characteristics to meet specific application requirements.

The immersion step involves submerging the sacrificial ionic scaffold (206) in the chosen solution (224) for a specific duration. The solution can be basic (221), acidic (222), or neutral (223), depending on the desired effect on the scaffold and the resulting hydrogel. The volume of the solution should be sufficient to completely cover the scaffold, ensuring uniform treatment. The container holding the scaffold and the solution can be sealed to prevent evaporation and maintain a constant solution concentration throughout the immersion period. The temperature of the solution can be controlled to influence the reaction kinetics and the rate of scaffold transformation. Gentle agitation or stirring can further enhance the uniformity of the treatment, promoting even penetration of the solution into the scaffold's structure. The predetermined immersion time is carefully chosen to balance the need for complete scaffold conversion with the avoidance of excessive degradation or damage to the hydrogel structure.

Immersing the scaffold for a specific period ensures that the solution has sufficient time to interact with the entire scaffold structure, promoting uniform transformation to the hydrogel. This controlled process enhances reproducibility, ensuring consistent results across multiple experiments or production runs. Furthermore, the ability to adjust the immersion time allows for fine-tuning of the hydrogel's properties. Shorter immersion times may be sufficient for thin or porous scaffolds, while thicker or denser scaffolds may require longer immersion times to achieve complete conversion.

Variations and alternatives exist for the immersion process. The immersion time can be optimized based on the specific scaffold and desired hydrogel properties. Alternative treatment methods, such as spraying or perfusion, can be employed for scaffolds with complex geometries or for applications requiring localized hydrogel formation. The composition, concentration, and pH of the solution can be varied to control the rate of scaffold transformation and the properties of the resulting hydrogel. The temperature of the solution can be adjusted to influence the reaction kinetics and tailor the hydrogel's characteristics.

Traditional methods for fabricating hydrogels often involve direct manipulation of the hydrogel precursor solution, which can be challenging due to the material's inherent compliance and tendency to deform. These methods typically rely on techniques like molding, casting, or extrusion, which can limit the achievable complexity and precision of the final hydrogel structure. Furthermore, these methods often require specialized equipment and complex procedures, making them time-consuming and costly. In contrast, the presently disclosed process employs a sacrificial ionic scaffold (206) as a template, offering a distinct advantage by providing a rigid, pre-shaped structure for hydrogel formation. This approach simplifies the fabrication process, enabling the creation of complex, three-dimensional hydrogel geometries with greater ease and precision. The use of a sacrificial scaffold also allows for a cleaner transition to the final hydrogel product, as the scaffold can be readily removed after the hydrogel has formed, leaving behind a pure hydrogel structure.

Another limitation of conventional hydrogel fabrication methods is the difficulty in controlling the hydrogel's properties, such as its swelling behavior and mechanical characteristics. Traditional methods often lack the ability to fine-tune these properties, limiting the hydrogel's adaptability to different applications. The process described herein overcomes this limitation by employing a tailored solution (224) to treat the sacrificial ionic scaffold (206). The solution's composition and pH can be adjusted to precisely control the degradation of the scaffold and the formation of the hydrogel (220), enabling the creation of hydrogels with specific swelling behaviors and mechanical properties. This tunability expands the range of potential applications for the hydrogel, making it a more versatile and adaptable material.

The use of a sacrificial ionic scaffold (206) in combination with a tailored solution (224) represents a significant departure from conventional hydrogel fabrication methods. This innovative approach provides a unique mechanism for creating hydrogels with complex shapes and precisely controlled properties. The scaffold's role as a temporary template simplifies the fabrication process and enables the creation of intricate hydrogel geometries, while the tailored solution allows for fine-tuning of the hydrogel's properties. This combination of a pre-shaped scaffold and a controlled chemical treatment distinguishes the disclosed process from traditional methods and provides a powerful new tool for creating advanced hydrogel materials. The ability to create complex, three-dimensional hydrogel structures with tailored properties opens up new possibilities in various fields, from biomedicine to materials science. The simplified fabrication process, facilitated by the use of a sacrificial scaffold, offers advantages in terms of cost, time, and scalability.

The articles and processes herein are illustrated further by the following Exampled, which are non-limiting.

### EXAMPLE

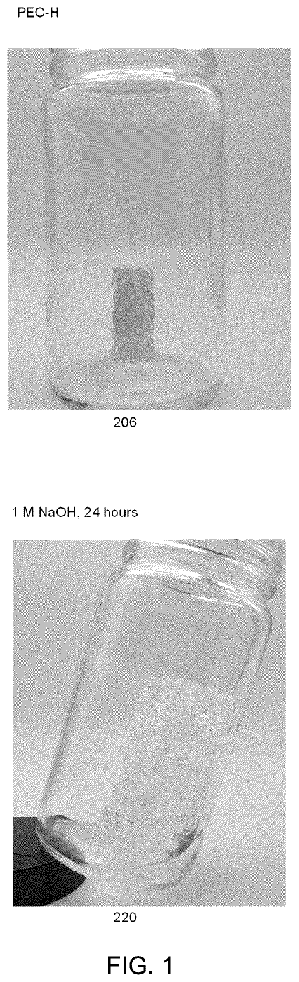

Transformation of a three-dimensionally printed polyelectrolyte complex (PEC) (206) into a hydrogel (220) upon treatment with a basic solution (221) was explored, and results are shown in FIG. 1. The figure showcases the efficacy of converting a rigid, pre-shaped scaffold into a soft, pliable hydrogel while maintaining the intricate structural details of the original scaffold. The figure provides a visual representation of leveraging a sacrificial ionic scaffold to create complex hydrogel geometries, wherein a sacrificial ionic scaffold (206) is treated with a basic solution to form a hydrogel. The scaffold, initially a rigid structure, undergoes a visible transformation upon immersion in the basic solution. This transformation is evident in the change in the material's appearance, from an opaque, solid structure to a translucent, gel-like material. The figure depicts two distinct stages of the process. The top image shows the printed PEC scaffold (206) before treatment. The scaffold (206) exhibits a defined, intricate structure, demonstrating the capability of additive manufacturing techniques to produce complex shapes. The bottom image shows the same scaffold after 24 hours of immersion in 1 M NaOH. The scaffold transformed into a hydrogel (220) exhibiting a swollen, translucent appearance while retaining the original shape and structural details. This visual confirmation demonstrates the controlled nature of the transformation process, where the basic solution selectively degrades the ionic scaffold while preserving its overall form. This controlled degradation is useful for creating hydrogels with precise geometries, as it avoids distortion or collapse of the delicate hydrogel structure during formation.

The figure shows the swelling behavior of the hydrogel (220) upon treatment with the basic solution (221). The hydrogel appears significantly larger in volume compared to the original scaffold, indicating its ability to absorb and retain water. This swelling behavior is characteristic of hydrogels and can be tailored by adjusting the composition of the scaffold and the treatment conditions. The swelling ratio, a property of hydrogels, can be controlled by varying the concentration and pH of the basic solution, as well as the immersion time. The figure also implicitly illustrates the interconnectivity of the hydrogel (220) with the sacrificial ionic scaffold (206). The hydrogel inherits the shape and structural details of the scaffold, demonstrating the intimate relationship between the two elements. This interconnectivity is useful for achieving precise control over the hydrogel's final geometry.

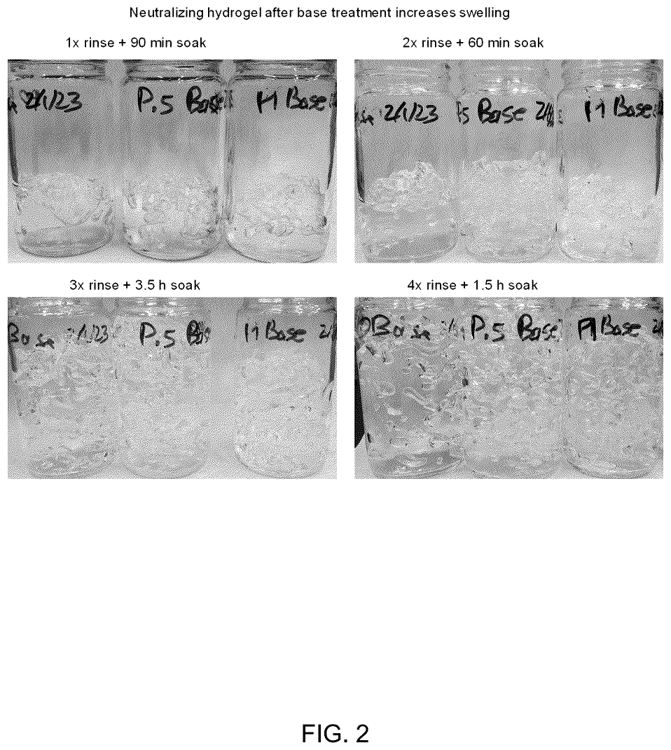

FIG. 2 shows the selectively tailorable swelling behavior of the hydrogel (220) formed from the sacrificial ionic scaffold (206) and the influence of neutralization on this behavior. The figure presents a series of images for the hydrogel's response to different rinsing and soaking conditions after the initial base treatment. These images provide insight into the hydrogel's swelling kinetics and its sensitivity to changes in pH, highlighting the tunability of its properties and its potential for applications requiring controlled swelling behavior. With regard to the four panels of images, each shows the hydrogel at a different stage of the rinsing and soaking process. The top left panel represents the hydrogel after one rinse and a 90-minute soak. The top right panel shows the hydrogel after two rinses and a 60-minute soak. The bottom left panel depicts the hydrogel after three rinses and a 3.5-hour soak. The bottom right panel shows the hydrogel after four rinses and a 1.5-hour soak. It should be appreciated that neutralizing the hydrogel after base treatment increases swelling, wherein the images show a progression in the hydrogel's swelling over time, with the hydrogel exhibiting increasing volume as the number of rinses and soaking time increase. This swelling progression highlights the hydrogel's dynamic response to changes in its environment, particularly its sensitivity to pH changes during the neutralization process. The increasing translucency of the hydrogel over time further suggests increased water absorption, correlating with the observed increase in swelling. The figure provides a visual demonstration of the hydrogel's dynamic nature and its responsiveness to external stimuli. This responsiveness is a characteristic of hydrogels, making them suitable for various applications requiring controlled swelling behavior, such as drug delivery or actuators. The figure illustrates the characteristics of post-treatment processing steps in influencing the hydrogel's final properties. The number of rinses and the soaking time affect the degree of swelling, highlighting the control over these parameters to achieve desired hydrogel characteristics. This ability to control and modulate the hydrogel's swelling behavior is a significant advantage, offering a means of customizing the hydrogel for specific applications.

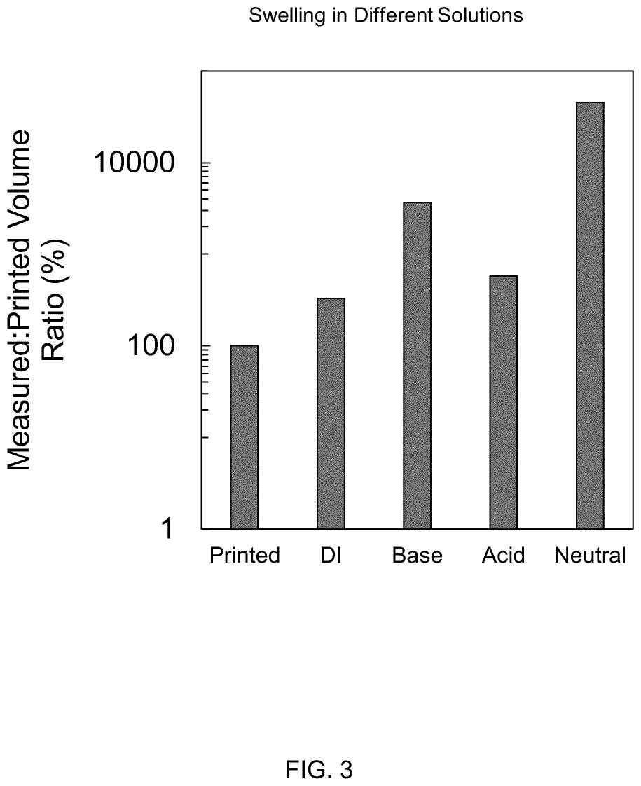

FIG. 3 provides results from a quantitative analysis of the hydrogel's (220) swelling behavior under different solution conditions, complementing the images shown in FIG. 2. The figure presents a bar chart comparing the swelling ratios of printed polyelectrolyte complex (PEC) samples after being subjected to various treatments. This quantitative data further elucidates the hydrogel's responsiveness to different chemical environments, reinforcing the tunability of its properties and its suitability for applications requiring precise control over swelling. The figure shows the swelling ratio, provided as the ratio of the final volume to the initial volume, on a logarithmic scale. This allows for a clear comparison of the swelling ratios across different treatment conditions, even when the ratios vary by orders of magnitude. The treatment processes include hydrogel being formed, neutralized, soaked, and its pH adjusted. The swelling ratios are presented for different conditions, including the printed state, soaking in deionized (DI) water, base treatment, acid treatment, and neutralization. Specifically, the first bar represents the printed PEC sample in its initial state, before any treatment. This serves as a baseline for comparison, demonstrating the initial volume of the sample. The second bar shows the swelling ratio after the sample is soaked in DI water. This condition demonstrates the hydrogel's inherent ability to absorb water, even in a neutral environment. The third bar represents the swelling ratio after base treatment, the key step in converting the PEC into a hydrogel. This condition demonstrates the significant swelling induced by the basic solution (221), which disrupts the ionic bonds within the scaffold and promotes water absorption. The fourth bar shows the swelling ratio after base treatment followed by acid treatment, where the pH of the soaking water is adjusted. The fifth bar represents the swelling ratio after base treatment followed by neutralization, demonstrating the effect of neutralizing the hydrogel after base treatment on its swelling behavior. The data in FIG. 3 clearly demonstrates the influence of the solution conditions on the hydrogel's (220) swelling ratio. The printed sample exhibits minimal swelling, as expected for a rigid, ionically crosslinked PEC (206). Soaking in DI water induces a moderate degree of swelling, indicating the hydrogel's inherent hydrophilicity. Base treatment leads to a dramatic increase in swelling, reflecting the disruption of ionic bonds and the resulting expansion of the polymer network. Acid treatment, following base treatment, reduces the swelling ratio, demonstrating the influence of pH on the hydrogel's properties. Neutralization, after base treatment, yields the highest swelling ratio, indicating that neutralizing the hydrogel maximizes its water absorption capacity. This quantitative data provides further evidence of the hydrogel's tunable swelling behavior, an advantage for various applications. The differences in swelling ratios across various conditions highlight the importance of selecting the treatment solutions and processing conditions to achieve desired hydrogel properties. The logarithmic scale of the y-axis in FIG. 3 emphasizes the significant differences in swelling ratios across the various treatment conditions. This allows for clear visualization of the dramatic increase in swelling caused by base treatment, the reduction in swelling due to acid treatment, and the maximizing effect of neutralization on swelling.

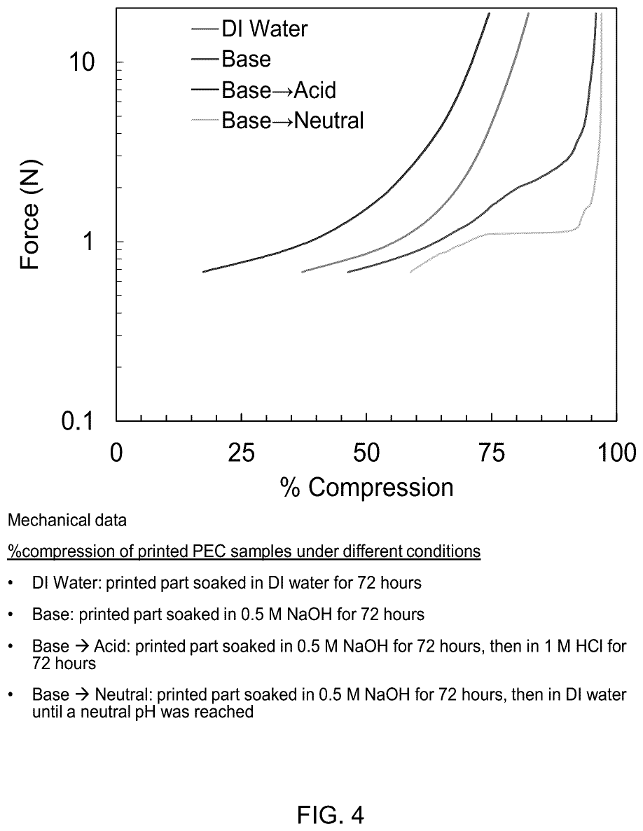

FIG. 4 shows mechanical data characterizing the compressive behavior of hydrogel (220) samples under different conditions, providing tunability of the hydrogel's properties. The figure displays a graph of force (in Newtons) as a function of percent compression for hydrogel samples subjected to various treatments. This data illustrates how the mechanical properties of the hydrogel, particularly its stiffness and compliance, can be modulated by adjusting the treatment conditions. This tunability is an advantage, allowing for the creation of hydrogels with specific mechanical characteristics tailored to different applications. The conditions shown in the figure match those described in FIG. 3, which include soaking in DI water, base treatment, base treatment followed by acid treatment, and base treatment followed by neutralization. The figure shows the effect of the hydrogel being soaked in water with different pH values to adjust its properties. The graph in FIG. 4 presents four distinct curves, each representing a different treatment condition. The blue curve corresponds to a printed PEC sample soaked in DI water for 72 hours. This condition demonstrates the mechanical behavior of the hydrogel in a neutral environment, serving as a baseline for comparison. The purple curve represents a sample treated with 0.5 M NaOH for 72 hours. This base treatment converts the PEC into a hydrogel, and the curve reflects the mechanical properties of the hydrogel in its base-treated state. The red curve corresponds to a sample treated with base, followed by immersion in 1 M HCl for 72 hours. This acid treatment, after the initial base treatment, modifies the hydrogel's properties, and the curve reflects the changes in its mechanical behavior. The gold curve represents a sample treated with base, followed by immersion in DI water until a neutral pH is reached. This neutralization step, after the initial base treatment, further modifies the hydrogel's properties, and the curve captures these changes in mechanical behavior. The legend below the figure provides detailed descriptions of each treatment condition. The data presented in FIG. 4 clearly demonstrates the influence of treatment conditions on the hydrogel's (220) mechanical properties. The curves show distinct differences in the force required to achieve a given level of compression, reflecting variations in the hydrogel's stiffness. The sample soaked in DI water exhibits the highest stiffness, requiring the greatest force for compression. The base-treated sample shows a decrease in stiffness compared to the DI water-soaked sample, indicating that the base treatment softens the hydrogel. The acid-treated sample exhibits a further decrease in stiffness compared to the base-treated sample, demonstrating the effect of acid treatment on the hydrogel's mechanical properties. The neutralized sample shows the lowest stiffness, requiring the least force for compression. This data correlates with the swelling data presented in FIG. 3, where the neutralized sample exhibited the highest swelling ratio. This correlation provides a relationship between swelling and stiffness, with more swollen hydrogels exhibiting lower stiffness. The figure thus demonstrates that the mechanical properties, like stiffness, of the hydrogel (220) can be tuned by changing the pH of the solution in which it is soaked. This comprehensive characterization reinforces the control over making hydrogel with tailored properties that is useful for applications requiring precise control over hydrogel properties. The figure clearly shows how different treatment conditions affect the hydrogel's stiffness, demonstrating the ability to tailor its mechanical properties for specific applications.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

### //PARTS LIST//

additive manufacturing polyelectrolyte resin 200
additively manufactured article 201
cationic poly-ammonium electrolyte 202
anionic organic acrylate monomer 203
photoinitiator 204
ion dispersion solvent 205
(poly-ammonium)-(poly-acrylate) electrolyte complex 206
covalent crosslinker 207
anionic poly-acrylate electrolyte 208
ionic linkage 209
ammonium group 210
acrylate group 211
amide bond 212
amide crosslinked polymer 213
vat photopolymerization 3D printer 214
photoabsorber 215
organic reactive diluent 216
anionic copolymer 217
chemical modifier 218
laser light/polymerizing light 219
hydrogel 220
basic solution 221
acidic solution 222
neutral solution 223
solution 224

What is claimed is:

1. A process for making a hydrogel (220) from a sacrificial ionic scaffold (206), the process comprising:
providing a sacrificial ionic scaffold (206) comprising a cationic poly-ammonium electrolyte (202) and an anionic poly-acrylate electrolyte (208) complexed together; and
treating the sacrificial ionic scaffold (206) with a basic solution to form the hydrogel (220).

2. The process of claim 1, wherein the sacrificial ionic scaffold (206) is formed by a process comprising:
providing an additive manufacturing polyelectrolyte resin (200) comprising the cationic poly-ammonium electrolyte (202), an anionic organic acrylate monomer (203), a photoinitiator (204), and a chemical modifier (218);
subjecting the additive manufacturing polyelectrolyte resin (200) to polymerizing light (219) to polymerize the anionic organic acrylate monomer (203) and form the anionic poly-acrylate electrolyte (208); and
complexing the cationic poly-ammonium electrolyte (202) with the anionic poly-acrylate electrolyte (208) to form the sacrificial ionic scaffold (206).

3. The process of claim 2, wherein the chemical modifier (218) is selected from the group consisting of a photoabsorber (215), an ion dispersion solvent (205) comprising an organic reactive diluent (216), and a combination thereof.

4. The process of claim 3, wherein the ion dispersion solvent (205) reacts with the anionic organic acrylate monomer (203) to form an anionic copolymer (217).

5. The process of claim 1, further comprising neutralizing the hydrogel (220) after treating with the basic solution.

6. The process of claim 1, wherein treating the sacrificial ionic scaffold (206) with the basic solution comprises immersing the sacrificial ionic scaffold (206) in the basic solution for at least 16 hours.

7. The process of claim 1, wherein the basic solution has a pH greater than 12.

8. The process of claim 1, further comprising soaking the hydrogel (220) in water after treating with the basic solution.

9. The process of claim 8, further comprising adjusting the pH of the water to tune the degree of swelling of the hydrogel (220).

10. The process of claim 2, wherein the additive manufacturing polyelectrolyte resin (200) further comprises a covalent crosslinker (207).

11. The process of claim 1, wherein the sacrificial ionic scaffold (206) is three-dimensionally printed.

12. A process for making a hydrogel (220) from a sacrificial ionic scaffold (206), the process comprising:
providing a sacrificial ionic scaffold (206) comprising a cationic poly-ammonium electrolyte (202) and an anionic poly-acrylate electrolyte (208) complexed together; and
treating the sacrificial ionic scaffold (206) with a solution to form the hydrogel (220).

13. The process of claim 12, wherein the solution is a basic solution.

14. The process of claim 13, wherein the basic solution has a pH greater than 12.

15. The process of claim 12, wherein the solution is an acidic solution.

16. The process of claim 15, wherein the acidic solution has a pH less than 7.

17. The process of claim 12, wherein the solution is a neutral solution.

18. The process of claim 17, wherein the neutral solution has a pH of approximately 7.

19. The process of claim 12, further comprising a second treating step of soaking the hydrogel (220) in a solution having a different pH than the solution used in the treating step.

20. The process of claim 12, wherein the sacrificial ionic scaffold (206) is formed by the process of claim 2.

21. The process of claim 12, wherein treating the sacrificial ionic scaffold (206) comprises immersing the sacrificial ionic scaffold (206) in the solution for a predetermined period of time.
